(19) United States
(12) Patent Application Publication
(10) Pub. No.: US 2023/0372905 A1
(43) Pub. Date: Nov. 23, 2023

(54) DIESEL OXIDATION CATALYST WITH ENHANCED HYDROCARBON LIGHT-OFF PROPERTIES

(71) Applicant: BASF Corporation, Florham Park, NJ (US)

(72) Inventors: M. Shahjahan Kazi, Iselin, NJ (US); Shiang Sung, Iselin, NJ (US); Claire Chunjuan Zhang, Mountainside, NJ (US); Xiaolai Zheng, Iselin, NJ (US); Sandip D. Shah, Iselin, NJ (US); Andrew Thoms, Iselin, NJ (US)

(21) Appl. No.: 18/031,458

(22) PCT Filed: Oct. 15, 2021
(86) PCT No.: PCT/US2021/071898

§ 371 Date: Apr. 12, 2023

Related U.S. Application Data
(60) Provisional application No. 63/092,574, filed on Oct. 16, 2020.

(51) Int. Cl. B01J 23/42; B01J 21/04; B01J 23/44; B01D 53/92; B01J 35/10; F01N 3/20; B01D 53/94

(52) U.S. Cl. CPC B01J 23/42; B01J 21/04; B01J 23/44; B01D 53/925; B01J 35/1061; B01J 35/1019; B01J 35/1014; F01N 3/2066; B01D 53/945; F01N 2370/02; F01N 2330/06; B01D 2258/012; B01D 2255/1021; B01D 2255/1023; B01D 2257/40; B01D 2257/502; B01D 2257/702

(57) ABSTRACT

The present disclosure relates to oxidation catalyst compositions for use in a close-coupled diesel oxidation catalyst (ccDOC) application, in which the ccDOC can function as a heat generator under high space velocity conditions. The oxidation catalyst compositions include a high surface area support material doped with at least one metal oxide, and a platinum group metal (PGM) supported on the doped high surface area support material.

This application claims the benefit of priority of U.S. Provisional Application No. 63/092,574, filed Oct. 16, 2020, the contents of which are incorporated by reference herein in their entirety.

The present disclosure is directed to catalyst compositions suitable for treating exhaust gas streams of an internal combustion engine, for example, a diesel engine, as well as catalytic articles and systems incorporating such compositions and methods of using the same.

Environmental regulations for emissions of internal combustion engines are becoming increasingly stringent throughout the world. Operation of a lean-burn engine, for example a diesel engine, may provide the user with excellent fuel economy due to its operation at high air/fuel ratios under fuel-lean conditions. However, diesel engines also emit exhaust gas emissions containing particulate matter (PM), unburned hydrocarbons (HCs), carbon monoxide (CO), and nitrogen oxides (NOₓ), wherein NOₓ describes various chemical species of nitrogen oxides, including nitrogen monoxide and nitrogen dioxide, among others. Two components of exhaust particulate matter are the soluble organic fraction (SOF) and the insoluble carbonaceous soot fraction. The SOF condenses on the soot in layers and may be derived from unburned diesel fuel and lubricating oils. The SOF can exist in diesel exhaust as a vapor or as an aerosol (i.e., fine droplets of liquid condensate), depending on the temperature of the exhaust gas. Soot may be composed of particles of carbon.

Oxidation catalysts comprising a precious metal, such as one or more platinum group metals (PGMs), dispersed on a refractory metal oxide support, such as alumina, may be used for treating exhaust of diesel engines in order to convert both hydrocarbon and carbon monoxide gaseous pollutants by catalyzing the oxidation of these pollutants to carbon dioxide and water. Such catalysts may be contained in units called diesel oxidation catalysts (DOC), which may be placed in the exhaust flow path from diesel engines to treat the exhaust before it vents to the atmosphere. Some diesel oxidation catalysts are formed on ceramic or metallic substrates upon which one or more catalyst coating compositions are deposited. In addition to the conversion of gaseous HC and CO emissions and particulate matter (SOF portion), oxidation catalysts that contain one or more PGMs promote the oxidation of NO to NO₂. Catalysts may be characterized by, e.g., their light-off temperature or the temperature at which 50% conversion is attained, also called T₅₀.

As regulations regarding vehicle emissions become more stringent, control of emissions during the cold start period has become increasingly important. For the 2024 model year, NOx emission regulations for heavy duty diesel vehicles require the tail pipe NOx to be equal or less than 0.1 g/HP-Hr. Catalysts used to treat the exhaust of internal combustion engines may be less effective during periods of relatively low temperature operation, such as the initial cold-start period of engine operation because the engine exhaust may not be at a temperature sufficiently high enough for efficient catalytic conversion of noxious components in the exhaust (e.g., below 200° C.). At low temperatures, exhaust gas treatment systems may not display sufficient catalytic activity for effectively treating hydrocarbons (HC), nitrogen oxides (NOₓ) and/or carbon monoxide (CO) emissions. For example, catalytic components such as selective catalytic reduction (SCR) catalyst components may be effective in converting NOₓ to N₂ at temperatures above 200° C. but may not exhibit sufficient activities at lower temperature regions (<200° C.) such as those found during cold-start or prolonged low-speed city driving. During the initial engine start up, covering, e.g., the first 400 seconds of operation, the exhaust temperature at the entrance of the SCR may be below 170° C., at which temperature the SCR may not yet be fully functional. Consequently, nearly 70% of the system out NOx may be emitted during the first 500 seconds of engine operation.

There presently exists a disconnect between DOC and SCR performance during cold start (e.g., NOx conversion performance before the SCR becomes functional), as the DOC becomes functional at a lower temperature than the SCR. One way to enhance the DOC+SCR system performance may be to promote SCR performance at the low temperature end of the spectrum by heating up the gas entering the SCR quickly so that SCR can be functioning before the total NOx emissions exceed the regulations. Achieving this result without relying on impractical electrical heating is challenging. Accordingly, there is a need in the art for systems which enhance the DOC+SCR system performance during low temperature operation.

The present disclosure provides an oxidation catalyst composition for use in a close-coupled diesel oxidation catalyst (ccDOC) application, in which the ccDOC can function as a heat generator. Typical oxidation catalyst compositions (e.g., DOC compositions) may not be suitable for use in such a ccDOC application. Close-coupled diesel oxidation catalyst applications may require a formulation operative for low temperature HC light-off in the presence of nitric oxide (NO), which suppresses HC light-off. In some embodiments according to the present disclosure, it has been found that certain mildly acidic, porous, high surface area support materials supporting a platinum group metal (PGM) can be employed to minimize the NO interference in HC light-off. Further, in some embodiments, such catalyst compositions as disclosed herein are suitable for use under high space velocity conditions, making them appropriate for application, e.g., in a ccDOC.

Accordingly, in some embodiments is provided an oxidation catalyst composition for use in a close coupled diesel oxidation catalyst (ccDOC), the oxidation catalyst composition comprising: a high surface area alumina support material doped with at least one metal oxide; and a platinum group metal (PGM) supported on the doped alumina support material; wherein the ccDOC is operative at a space velocity of 100,000 h⁻¹ or greater to light off hydrocarbons at a temperature below about 250° C. in the presence of nitric oxide (NO); and wherein the doped high surface area alumina support material is a large pore material having an average pore opening size of at least about 15 nm; the doped high surface area alumina support material possesses a total acidity greater than 300 μmole per gram, or both.

In some embodiments, the doped high surface area alumina support material has a Brönsted acidity greater than 1 mole per gram.

In some embodiments, the at least one metal oxide is an oxide of titanium, silicon, manganese, iron, nickel, zinc, zirconium, tin, or any combination thereof. In some embodiments, the at least one metal oxide is chosen from titanium oxide, silicon oxide, manganese oxide, iron oxide, nickel oxide, zinc oxide, zirconium oxide, tin oxide, and combinations thereof. In some embodiments, the at least one metal oxide is chosen from silica, titania, manganese oxide, and combinations thereof. In some embodiments, the at least one metal oxide is titania.

In some embodiments, the oxidation catalyst composition comprises from about 1% to about 20% by weight of the at least one metal oxide, based on the total weight of the oxidation catalyst composition.

In some embodiments, the oxidation catalyst composition comprises from about 1% to about 10% by weight of the PGM, based on the total weight of the oxidation catalyst composition. In some embodiments, the PGM is platinum or a mixture of platinum and palladium. In some embodiments, the PGM is a mixture of platinum and palladium having a platinum to palladium ratio by weight of from about 1 to about 10.

In some embodiments, the oxidation catalyst composition effectively oxidizes hydrocarbons (HC) in an exhaust gas stream comprising HC and nitrogen oxides (NOx), wherein the exhaust gas stream has a HC to CO ratio of 100 or more. In some embodiments, the oxidation catalyst composition effectively oxidizes hydrocarbons (HC) in an exhaust gas stream comprising HC and nitrogen oxides (NOx), wherein the exhaust gas stream has a HC to CO ratio ranging from 100 to 10,000.

In some embodiments, the high surface area alumina support material has a surface area of at least about 90 m²/g. In some embodiments, the high surface area alumina support material has a surface area from about 90 m²/g to about 150 m²/g.

In some embodiments, the high surface area alumina support material is a large pore material having an average pore opening size of at least about 15 nm. In some embodiments, the high surface area alumina support material is a large pore material having an average pore opening size from about 15 nm to about 200 nm, or from about 20 nm to about 50 nm.

In some embodiments, the high surface area alumina support material is doped with from about 1% to about 20% titania by weight, based on the weight of the doped high surface area alumina support material. In some embodiments, the high surface area alumina support material is doped with from about 1% to about 10% titania by weight, or from about 3% to about 7% titania by weight, based on the weight of the doped high surface area alumina support material.

In some embodiments, the oxidation catalyst composition further comprises manganese oxide.

In some embodiments, the oxidation catalyst composition comprises from about 1% to about 5% by weight of platinum, palladium, or a mixture thereof, based on the total weight of the oxidation catalyst composition; wherein the high surface area alumina support material is doped with from about 5% to about 10% titania by weight, based on the weight of the doped high surface area alumina support material; and wherein the high surface area alumina support material has a surface area of from about 90 m²/g to about 150 m²/g, an average pore opening size of from about 15 nm to about 200 nm, or both

In some embodiments, is provided a system for treatment of an exhaust gas stream from an internal combustion engine containing hydrocarbons (HCs), carbon monoxide (CO), and nitrogen oxides (NOₓ), the system comprising: a close coupled diesel oxidation catalyst (ccDOC) article located downstream of the internal combustion engine, the ccDOC article comprising a substrate, and the oxidation catalyst composition as disclosed herein, disposed on at least a portion of the substrate; a diesel oxidation catalyst (DOC) article located downstream of the engine and adapted for oxidation of HCs, CO and NOx; and a selective catalytic reduction (SCR) article adapted for the reduction of nitrogen oxides (NOₓ), located downstream of the DOC article; wherein all catalyst articles are in fluid communication with the exhaust gas stream. In some embodiments, a system comprising an engine and a close coupled diesel oxidation catalyst has fewer than 5 catalytic articles in fluid communication between the engine and the close coupled diesel oxidation catalyst. In some embodiments, a system comprising an engine and a close coupled diesel oxidation catalyst has fewer than 4 catalytic articles in fluid communication between the engine and the close coupled diesel oxidation catalyst. In some embodiments, a system comprising an engine and a close coupled diesel oxidation catalyst has fewer than 3 catalytic articles in fluid communication between the engine and the close coupled diesel oxidation catalyst. In some embodiments, a system comprising an engine and a close coupled diesel oxidation catalyst has fewer than 2 catalytic articles in fluid communication between the engine and the close coupled diesel oxidation catalyst. In some embodiments, a system comprising an engine and a close coupled diesel oxidation catalyst has no catalytic articles in fluid communication between the engine and the close coupled diesel oxidation catalyst.

In some embodiments, the present disclosure provides a method for reducing HCs and NOₓ present in an exhaust gas stream from an internal combustion engine, the method comprising: introducing a quantity of HCs into the exhaust stream to form an exhaust gas stream enriched in HCs; contacting the HC-enriched exhaust gas stream with the oxidation catalyst composition as disclosed herein, wherein the oxidation catalyst composition is disposed on a substrate, and positioned downstream of the internal combustion engine in a close coupled position, to generate an exotherm by combustion of the HCs, thereby forming a heated, first effluent; contacting the heated, first effluent with a diesel oxidation catalyst adapted for the oxidation of HCs and NO, thereby forming a second effluent with reduced levels of HCs and elevated levels of NO₂; injecting a reductant into the second effluent exiting the diesel oxidation catalyst to obtain a third effluent; and contacting the third effluent with a SCR catalyst adapted for the reduction of NOₓ, thereby forming a treated exhaust gas stream with reduced levels of HCs and NOₓ.

These and other features, aspects, and advantages of the disclosure will be apparent from a reading of the following detailed description together with the accompanying drawings, which are briefly described below. The disclosure includes any combination of two, three, four, or more of the above-noted embodiments as well as combinations of any two, three, four, or more features or elements set forth in this disclosure, regardless of whether such features or elements are expressly combined in a specific embodiment description herein. This disclosure is intended to be read holistically such that any separable features or elements of the disclosure, in any of its various aspects and embodiments, should be viewed as intended to be combinable unless the context clearly dictates otherwise. Other aspects and advantages of the present disclosure will become apparent from the following.

### BRIEF DESCRIPTION OF THE DRAWINGS

In order to provide an understanding of embodiments of the disclosure, reference is made to the appended drawings, in which reference numerals refer to components of exemplary embodiments. The drawings are exemplary only, and should not be construed as limiting the disclosure. The disclosure described herein is illustrated by way of example and not by way of limitation in the accompanying figures. For simplicity and clarity of illustration, features illustrated in the figures are not necessarily drawn to scale. For example, the dimensions of some features may be exaggerated relative to other features for clarity. Further, where considered appropriate, reference labels have been repeated among the figures to indicate corresponding or analogous elements.

FIG. 1A is a perspective view of an exemplary honeycomb-type substrate which may comprise an oxidation catalyst composition in accordance with the present disclosure;

FIG. 1B is a partial cross-sectional view enlarged relative to FIG. 1A and taken along a plane parallel to the end faces of the substrate of FIG. 1A, which shows an enlarged view of a plurality of the gas flow passages shown in FIG. 1A, in an embodiment wherein the substrate is a flow-through substrate;

FIG. 2 is a cutaway view of an exemplary wall-flow filter;

FIGS. 3A, 3B, and 3C are non-limiting illustrations of exemplary coating configurations;

FIG. 4 is a schematic depiction of an embodiment of an emission treatment system in which a ccDOC catalyst article of the present disclosure is utilized:

FIG. 5 is a schematic depiction of an embodiment of an emission treatment system in which a ccDOC catalyst article of the present disclosure is utilized;

FIG. 6 is a graph of CO₂ generation versus temperature for an embodiment of the disclosure;

FIG. 7 is a graph of CO₂ generation versus temperature for an embodiment of the disclosure;

FIG. 8 is a graph of CO₂ generation versus temperature for an embodiment of the disclosure;

FIG. 9 is a graph of CO₂ generation versus temperature for embodiments of the disclosure;

FIG. 10 is a graph of CO₂ generation versus temperature for an embodiment of the disclosure;

FIG. 11 is a graph of CO₂ generation versus temperature for an embodiment of the disclosure;

FIG. 12 is a graph of CO₂ generation versus temperature for embodiments of the disclosure;

FIG. 13 is a graph of N₂O and CO₂ generation versus temperature for an embodiment of the disclosure;

FIG. 14 is a graph of CO₂ generation versus temperature for an embodiment of the disclosure;

FIG. 15 is a graph of CO₂ generation versus temperature for an embodiment of the disclosure;

FIG. 16 is a graph of NO₂, N₂O and CO₂ generation versus temperature for an embodiment of the disclosure;

FIG. 17 is a graph of NO₂, N₂O and CO₂ generation versus temperature for an embodiment of the disclosure;

FIG. 18 shows infrared absorption spectra for embodiments of the disclosure;

FIG. 19 shows infrared absorption spectra for embodiments of the disclosure;

FIG. 20 shows bar graphs of DOC temperature out versus temperature in for embodiments of the disclosure (fresh);

FIG. 21 shows bar graphs of DOC temperature out versus temperature in for embodiments of the disclosure (fresh);

FIG. 22 shows bar graphs of DOC temperature out versus temperature in for embodiments of the disclosure (aged);

FIG. 23 is a line graph of DOC temperature out versus temperature in for embodiments of the disclosure with 0.6% by volume diesel fuel injection; and

FIG. 24 is a line graph of DOC temperature out versus temperature in for embodiments of the disclosure with 1% by volume diesel fuel injection.

In some embodiments, the present disclosure provides an oxidation catalyst composition for use in a close-coupled diesel oxidation catalyst (ccDOC) application, in which the ccDOC can function as a heat generator by oxidizing (i.e., combusting) hydrocarbons (HCs), available either from in-cylinder, rich HC injection or in-exhaust diesel fuel injection. In some embodiments, this HC combustion rapidly heats up the exhaust gas stream exiting the ccDOC; consequently, the exhaust stream entering a downstream catalyst article, e.g., a selective catalytic reduction (SCR) catalyst article has an elevated temperature, thereby promoting cold-start NOx conversion performance of the SCR catalyst.

In some embodiments, the presence of nitric oxide (NO) in an exhaust gas stream suppresses HC combustion (increased light-off temperature) within oxidation catalyst articles such as DOC articles. In some embodiments, fuel combustion in the oxidation catalyst article under these in-exhaust diesel fuel injection (“in-pipe” fuel injection) conditions occur at about the temperature at which the fuel is injected, and at high space velocities. Typical oxidation catalyst (e.g., DOC) compositions may not be suitable for use under such conditions; therefore, the close-coupled application may require an oxidation catalyst having a different formulation. In some embodiments according to the present disclosure, it has been found that certain mildly acidic, porous, high surface area support materials supporting a platinum group metal (PGM) can minimize the NO interference in HC light-off. Further, as disclosed herein, in some embodiments catalyst compositions containing such mildly acidic, porous, high surface area support materials supporting a PGM are suitable for use under high space velocity conditions, making them appropriate for a ccDOC application.

The present disclosure now will be described more fully hereinafter. This disclosure may, however, be embodied in many different forms and should not be construed as limited to the embodiments set forth herein.

### Definitions

The articles “a” and “an” herein refer to one or to more than one (e.g. at least one) of the grammatical object. Any ranges cited herein are inclusive. The term “about” used throughout is used to describe and account for small fluctuations. For instance, “about” may mean the numeric value may be modified by ±5%, ±4%, ±3%, ±2%, ±1%, ±0.5%, ±0.4%, ±0.3%, ±0.2%, ±0.1% or ±0.05%. All numeric values are modified by the term “about” whether or not explicitly indicated. Numeric values modified by the term “about” include the specific identified value. For example, “about 5.0” includes 5.0.

The term “abatement” means a decrease in the amount, caused by any means.

The term “associated” means for instance “equipped with”, “connected to” or in “communication with”, for example “electrically connected” or in “fluid communication with” or otherwise connected in a way to perform a function. The term “associated” may mean directly associated with or indirectly associated with, for instance through one or more other articles or elements.

“Average particle size” is synonymous with D₅₀, meaning half of the population of particles has a particle size above this point, and half below. Particle size refers to primary particles. Particle size may be measured by laser light scattering techniques, with dispersions or dry powders, for example according to ASTM method D4464. D₉₀ particle size distribution indicates that 90% of the particles (by number) have a Feret diameter below a certain size as measured by Scanning Electron Microscopy (SEM) or Transmission Electron Microscopy (TEM) for submicron size particles, and a particle size analyzer for the support-containing particles (micron size).

The term “catalyst” refers to a material that promotes a chemical reaction. The catalyst includes the “catalytically active species” and the “carrier” that carries or supports the active species.

The term “functional article” means an article comprising a substrate having a functional coating composition disposed thereon, in particular a catalyst and/or sorbent coating composition.

The term “catalytic article” in the disclosure means an article comprising a substrate having a catalyst coating composition.

“CSF” refers to a catalyzed soot filter, which is a wall-flow monolith. A wall-flow filter consists of alternating inlet channels and outlet channels, where the inlet channels are plugged on the outlet end and the outlet channels are plugged on the inlet end. A soot-carrying exhaust gas stream entering the inlet channels is forced to pass through the filter walls before exiting from the outlet channels. In addition to soot filtration and regeneration, a CSF may carry oxidation catalysts to oxidize CO and HC to CO₂ and H₂O, or oxidize NO to NO₂ to accelerate downstream SCR catalysis or to facilitate the oxidation of soot particles at lower temperatures. A CSF, when positioned behind a LNT catalyst, can have a H₂S oxidation functionality to suppress H₂S emission during the LNT desulfation process. An SCR catalyst can also be, in some embodiments, coated directly onto a wall-flow filter, which is called a SCRoF.

“DOC” refers to a diesel oxidation catalyst, which converts hydrocarbons and carbon monoxide in the exhaust gas of a diesel engine. Typically, a DOC comprises one or more platinum group metals such as palladium and/or platinum; a support material such as alumina; zeolites for HC storage; and optionally promoters and/or stabilizers.

“LNT” refers to a lean NOₓ trap, which is a catalyst containing a platinum group metal, ceria, and an alkaline earth trap material suitable to adsorb NOₓ during lean conditions (for example, BaO or MgO). Under rich conditions, NOₓ is released and reduced to nitrogen.

As used herein, the phrase “catalyst system” refers to a combination of two or more catalysts, for example, a combination of a present oxidation catalyst and another catalyst, for example, a lean NOₓ trap (LNT), a catalyzed soot filter (CSF), or a selective catalytic reduction (SCR) catalyst. The catalyst system may alternatively be in the form of a washcoat in which the two or more catalysts are mixed together or coated in separate layers.

The term “configured” as used in the description and claims is intended to be an open-ended term as are the terms “comprising” or “containing”. The term “configured” is not meant to exclude other possible articles or elements. The term “configured” may be equivalent to “adapted.”

In general, the term “effective” means for example from about 35% to 100% effective, for instance from about 40%, about 45%, about 50% or about 55% to about 60%, about 65%, about 70%, about 75%, about 80%, about 85%, about 90% or about 95%, regarding the defined catalytic activity or storage/release activity, by weight or by moles.

“Essentially free” means “little or no” or “no intentionally added,” and also having only trace and/or inadvertent amounts. For instance, in certain embodiments, “essentially free” means less than 2 wt. % (weight %), less than 1.5 wt. %, less than 1.0 wt. %, less than 0.5 wt. %, 0.25 wt. % or less than 0.01 wt. %, based on the weight of the indicated total composition.

The term “exhaust stream” or “exhaust gas stream” refers to any combination of flowing gas that may contain solid or liquid particulate matter. The stream comprises gaseous components and is for example exhaust of a lean burn engine, which may contain certain non-gaseous components such as liquid droplets, solid particulates and the like. The exhaust gas stream of a combustion engine typically further comprises combustion products (CO₂ and H₂O), products of incomplete combustion (carbon monoxide (CO) and hydrocarbons (HC)), oxides of nitrogen (NOₓ), combustible and/or carbonaceous particulate matter (soot), and un-reacted oxygen and nitrogen. As used herein, the terms “upstream” and “downstream” refer to relative directions according to the flow of an engine exhaust gas stream from an engine towards a tailpipe, with the engine in an upstream location and the tailpipe and any pollution abatement articles such as filters and catalysts being downstream from the engine. The inlet end of a substrate is synonymous with the “upstream” end or “front” end. The outlet end is synonymous with the “downstream” end or “rear” end. An upstream zone is upstream of a downstream zone. An upstream zone may be closer to the engine or manifold, and a downstream zone may be further away from the engine or manifold.

The term “in fluid communication” is used to refer to articles positioned on the same exhaust line, i.e., a common exhaust stream passes through articles that are in fluid communication with each other. Articles in fluid communication may be adjacent to each other in the exhaust line. Alternatively, articles in fluid communication may be separated by one or more articles, also referred to as “washcoated monoliths.”

As used herein, the terms “nitrogen oxides” or “NOₓ” designate the oxides of nitrogen, such as NO or NO₂.

As used herein, “impregnated” or “impregnation” refers to permeation of the catalytic material into the porous structure of the support material.

As used herein, the term “support” or “support material” refers to any high surface area material, for example a metal oxide material, upon which a catalytic precious metal is applied. The term “on a support” means “dispersed on”, “incorporated into”, “impregnated into”, “on”, “in”, “deposited on” or otherwise associated with.

As used herein, the term “selective catalytic reduction” (SCR) refers to the catalytic process of reducing oxides of nitrogen to dinitrogen (N₂) using a nitrogenous reductant.

As used herein, the term “substrate” refers to the monolithic material onto which the catalyst composition, that is, catalytic coating, is disposed, typically in the form of a washcoat. some embodiments, the substrates are flow-through monoliths and monolithic wall-flow filters. Flow-through and wall-flow substrates are also taught, for example, in International Application Publication No. WO2016/070090, which is incorporated herein by reference. A washcoat is formed by preparing a slurry containing a specified solids content (e.g., 30-90% by weight) of catalyst in a liquid, which is then coated onto a substrate and dried to provide a washcoat layer. Reference to “monolithic substrate” means a unitary structure that is homogeneous and continuous from inlet to outlet. A washcoat is formed by preparing a slurry containing a certain solid content (e.g., 20%-90% by weight) of particles in a liquid vehicle, which is then coated onto a substrate and dried to provide a washcoat layer.

The terms “on” and “over” in reference to a coating layer may be used synonymously. The term “directly on” means in direct contact with. The disclosed articles are referred to in certain embodiments as comprising one coating layer “on” a second coating layer, and such language is intended to encompass embodiments with intervening layers, where direct contact between the coating layers is not required (i.e., “on” is not equated with “directly on”).

As used herein, the term “washcoat” has its usual meaning in the art of a thin, adherent coating of a catalytic or other material applied to a substrate material, such as a honeycomb-type carrier member, which is sufficiently porous to permit the passage of the gas stream being treated. The washcoat containing the metal-promoted molecular sieve of the disclosure can optionally comprise a binder chosen from silica, alumina, titania, zirconia, ceria, or a combination thereof. The loading of the binder is about 0.1 to 10 wt. % based on the weight of the washcoat. As used herein and as described in Heck, Ronald and Farrauto, Robert, Catalytic Air Pollution Control, New York: Wiley-Interscience, 2002, pp. 18-19, a washcoat layer includes a compositionally distinct layer of material disposed on the surface of a monolithic substrate or an underlying washcoat layer. A substrate can contain one or more washcoat layers, and each washcoat layer can be different in some way (e.g., may differ in physical properties thereof such as, for example particle size or crystallite phase) and/or may differ in the chemical catalytic functions.

The term “vehicle” means, for instance, any vehicle having an internal combustion engine and includes, but is not limited to, passenger automobiles, sport utility vehicles, minivans, vans, trucks, buses, refuse vehicles, freight trucks, construction vehicles, heavy equipment, military vehicles, farm vehicles and the like.

Unless otherwise indicated, all parts and percentages are by weight. “Weight percent (wt %),” if not otherwise indicated, is based on an entire composition free of any volatiles, that is, based on dry solids content.

All methods described herein can be performed in any suitable order unless otherwise indicated herein or otherwise clearly contradicted by context. The use of any and all examples, or exemplary language (e.g., “such as”) provided herein, is intended merely to better illuminate the materials and methods and does not pose a limitation on the scope unless otherwise claimed No language in the specification should be construed as indicating any non-claimed element as essential to the practice of the disclosed materials and methods.

All U.S. patent applications, published patent applications and patents referred to herein are hereby incorporated by reference.

### Non-Limiting Example Embodiments

Without limitation, some embodiments of the disclosure include:

1. An oxidation catalyst composition for use in a close coupled diesel oxidation catalyst (ccDOC), wherein the oxidation catalyst composition comprises:
a high surface area alumina support material doped with at least one metal oxide; and
a platinum group metal (PGM) supported on the doped alumina support material;
wherein the ccDOC is operative at a space velocity of 100,000 h⁻¹ or greater to light off hydrocarbons at a temperature below about 250° C. in the presence of nitric oxide (NO); and wherein:
the doped high surface area alumina support material is a large pore material having an average pore opening size of at least about 15 nm; and/or
the doped high surface area alumina support material possesses a total acidity greater than 300 μmole per gram.
   2. The oxidation catalyst composition of embodiment 1, wherein the doped high surface area alumina support material has a Brönsted acidity greater than 1 μmole per gram.
   3. The oxidation catalyst composition of embodiment 1, wherein the at least one metal oxide is an oxide of titanium, silicon, manganese, iron, nickel, zinc, zirconium, tin, or any combination thereof.
   4. The oxidation catalyst composition of embodiment 1, wherein the at least one metal oxide is chosen from silica, titania, manganese oxide, and combinations thereof.
   5. The oxidation catalyst composition of claim 1, wherein the at least one metal oxide is titania.
   6. The oxidation catalyst composition of embodiment 1, wherein the oxidation catalyst composition comprises from about 1% to about 20% by weight of the at least one metal oxide, based on the total weight of the oxidation catalyst composition.
   7. The oxidation catalyst composition of embodiment 1, wherein the oxidation catalyst composition comprises from about 1% to about 10% by weight of the PGM, based on the total weight of the oxidation catalyst composition.
   8. The oxidation catalyst composition of embodiment 1, wherein the PGM is platinum or a mixture of platinum and palladium.
   9. The oxidation catalyst composition of embodiment 1, wherein the PGM is a mixture of platinum and palladium having a platinum to palladium ratio by weight of from about 1 to about 10.
   10. The oxidation catalyst composition of embodiment 1, wherein the oxidation catalyst composition effectively oxidizes hydrocarbons (HC) in an exhaust gas stream comprising HC and nitrogen oxides (NOx), the exhaust gas stream having a HC to CO ratio of 100 or more.
   11. The oxidation catalyst composition of embodiment 1, wherein the high surface area alumina support material has a surface area of at least about 90 m²/g.
   12. The oxidation catalyst composition of embodiment 1, wherein the high surface area alumina support material has a surface area ranging from about 90 m²/g to about 150 m²/g.
   13. The oxidation catalyst composition of embodiment 1, wherein the high surface area alumina support material is a large pore material having an average pore opening size of at least about 15 nm.
   14. The oxidation catalyst composition of embodiment 1, wherein the high surface area alumina support material is a large pore material having an average pore opening size ranging from about 15 nm to about 200 nm, or from about 20 nm to about 50 nm.
   15. The oxidation catalyst composition of embodiment 1, wherein the high surface area alumina support material is doped with from about 1% to about 20% titania by weight, based on the weight of the doped high surface area alumina support material.
   16. The oxidation catalyst composition of embodiment 1, wherein the high surface area alumina support material is doped with from about 1% to about 10% titania by weight, or from about 3% to about 7% titania by weight, based on the weight of the doped high surface area alumina support material.
   17. The oxidation catalyst composition of embodiment 15, further comprising manganese oxide.
   18. The oxidation catalyst composition of claim 1, wherein the oxidation catalyst composition comprises from about 1% to about 5% by weight of platinum, palladium, or a mixture thereof, based on the total weight of the oxidation catalyst composition;
wherein the high surface area alumina support material is doped with from about 5% to about 10% titania by weight, based on the weight of the doped high surface area alumina support material; and
wherein the high surface area alumina support material has a surface area ranging from about 90 m²/g to about 150 m²/g, an average pore opening size of from about 15 nm to about 200 nm, or both
   19. A system for treatment of an exhaust gas stream from an internal combustion engine containing hydrocarbons (HCs), carbon monoxide (CO), and nitrogen oxides (NOₓ), the system comprising:
a close coupled diesel oxidation catalyst (ccDOC) article located downstream of the internal combustion engine, wherein the ccDOC article comprises a substrate, and the oxidation catalyst composition of any of claims 1-17, disposed on at least a portion of the substrate;
a diesel oxidation catalyst (DOC) article located downstream of the engine and adapted for oxidation of HCs, CO and NOx; and
a selective catalytic reduction (SCR) article adapted for the reduction of nitrogen oxides (NOₓ), located downstream of the DOC article;
wherein all catalyst articles are in fluid communication with the exhaust gas stream.
   20. A method for reducing HCs and NOₓ present in an exhaust gas stream from an internal combustion engine, the method comprising:
introducing a quantity of HCs into the exhaust stream to form an exhaust gas stream enriched in HCs;
contacting the HC-enriched exhaust gas stream with the oxidation catalyst composition of any of claims 1-18, wherein the oxidation catalyst composition is disposed on a substrate, and positioned downstream of the internal combustion engine in a close coupled position, to generate an exotherm by combustion of the HCs, thereby forming a heated, first effluent;
contacting the heated, first effluent with a diesel oxidation catalyst adapted for the oxidation of HCs and NOₓ thereby forming a second effluent with reduced levels of HCs and elevated levels of NO₂;
injecting a reductant into the second effluent exiting the diesel oxidation catalyst to obtain a third effluent; and
contacting the third effluent with a SCR catalyst adapted for the reduction of NON, thereby forming a treated exhaust gas stream with reduced levels of HCs and NOR.

### Oxidation Catalyst (DOC) Composition

In some embodiments, the present disclosure provides an oxidation catalyst composition for use in a close coupled diesel oxidation catalyst (ccDOC), the composition comprising a high surface area, large pore opening support material doped with at least one metal oxide; and a platinum group metal (PGM) supported on the doped high surface area, large pore opening support material. Exemplary components of the composition are described further herein below.

### Support Material

In some embodiments, the oxidation catalyst composition as described herein comprises a high surface area support material doped with at least one metal oxide. As used herein, the term “support material” refers to the underlying high surface area opening material upon which catalytic species (e.g., platinum group metal) are carried, such as through precipitation, association, dispersion, impregnation, or other suitable methods.

By “high surface area” is meant the support material generally exhibits a BET surface area in excess of 60 m²/g, and often up to about 200 m²/g or higher, for example, up to about 350 m²/g. “BET surface area” has its usual meaning of referring to the Brunauer-Emmett-Teller method for determining surface area by N₂ adsorption measurements. Unless otherwise stated, “surface area” refers to BET surface area. In some embodiments, the high surface area opening support material has a surface area of at least about 90 m²/g, such as from about 90 m²/g to about 200 m²/g, or from about 90 m²/g to about 150 m²/g.

In some embodiments, the high surface area support material is a large pore opening material. By “large pore opening” is meant that the support particles have an average pore opening size of at least about 15 nm, such as from about 15 nm to about 200 nm. In some embodiments, greater than about 80% of the pores are larger than 20 nm in diameter. In some embodiments, the pore diameter is from about 20 nm to about 50 nm. Pore diameter can be determined using BET-type N₂ adsorption or desorption experiments.

In some embodiments, the support material comprises a refractory metal oxide, which exhibits chemical and physical stability at high temperatures, such as the temperatures associated with gasoline or diesel engine exhaust. Exemplary refractory metal oxides include alumina, silica, zirconia, titania, and the like, as well as physical mixtures or chemical combinations thereof, including, e.g., atomically-doped combinations and including, e.g., activated compounds such as activated alumina. In some embodiments, the high surface area, large pore opening support material is chosen from silica, alumina, titania, and combinations thereof. Useful commercial aluminas used as starting materials in exemplary processes include activated aluminas, such as high bulk density gamma-alumina, low or medium bulk density large pore gamma-alumina and low bulk density large pore boehmite and gamma-alumina. In some embodiments, the high surface area, large pore opening support material comprises alumina.

In some embodiments, high surface area, large pore opening support materials useful in the catalyst compositions disclosed herein are doped with at least one metal oxide. In some embodiments, the high surface area, large pore opening support material comprises from about 1% to about 20% by weight of the at least one metal oxide, such as from about 1% to about 15%, from about 1% to about 10%, or from about 3% to about 7% by weight of the at least one metal oxide, based on the weight of the doped high surface area, large pore opening support material. In some embodiments, the high surface area, large pore opening support material comprises from about 1%, about 2%, about 3%, about 4%, about 5%, about 6%, about 7%, about 8%, about 9%, or about 10%, to about 11%, about 12%, about 13%, about 14%, about 15%, about 16%, about 17%, about 18%, about 19%, or about 20% by weight of the at least one metal oxide, based on the weight of the doped high surface area, large pore opening support material.

Suitable metal oxides include oxides of titanium, silicon, manganese, iron, nickel, zinc, zirconium, tin, and combinations thereof. In some embodiments, the at least one metal oxide is an oxide of titanium, silicon, manganese, iron, nickel, zinc, zirconium, tin, or any combination thereof. In some embodiments, the at least one metal oxide is chosen from silica, titania, and combinations thereof. In some embodiments, the at least one metal oxide is titania.

In some embodiments, the high surface area, large pore opening support material is silica doped with titania, manganese oxide, iron oxide, nickel oxide, zinc oxide, zirconia, tin oxide, or any combination thereof.

In some embodiments, the high surface area, large pore opening support material is alumina doped with titania, silica, manganese oxide, iron oxide, nickel oxide, zinc oxide, zirconia, tin oxide, or any combination thereof. In some embodiments, the high surface area, large pore opening support material is alumina doped with titania.

In some embodiments, the high surface area, large pore opening support material is titania doped with alumina, silica, manganese oxide, iron oxide, nickel oxide, zinc oxide, zirconia, tin oxide, or any combination thereof.

In some embodiments, the high surface area, large pore opening support material is alumina doped with from about 1% to about 20%, about 1% to about 10%, or from about 3% to about 7% titania by weight, based on the weight of the doped high surface area, large pore opening support material. In some embodiments, titania doped alumina is further doped with silica. In some embodiments, the high surface area, large pore opening support material is alumina doped with about 5%, or about 10% titania by weight, based on the weight of the doped high surface area, large pore opening support material.

In some embodiments, the dopant metal oxide(s) can be introduced using, for example, an incipient wetness impregnation technique or through usage of colloidal mixed oxide particles. In some embodiments, the at least one metal oxide is present in the doped high surface area, large pore opening support material in the form of a mixed oxide, meaning the metal oxides are covalently bound with one another through shared oxygen atoms.

### Platinum Group Metal (PGM)

In some embodiments, the ccDOC composition as described herein comprises a platinum group metal (PGM) supported on the doped high surface area, large pore opening support material. PGMs include platinum (Pt), palladium (Pd), ruthenium (Ru), rhodium (Rh), osmium (Os), iridium (Ir), gold (Au), and mixtures thereof. The PGM can include the PGM in any valence state. As used herein, the term “PGM” refers both to a catalytically active form of the respective PGM, as well as the corresponding PGM compound, complex, or the like which, upon calcination or use of the catalyst, decomposes or otherwise converts to the catalytically active form, usually the metal or the metal oxide. The PGM may be in metallic form, with zero valence (“PGM(0)”), or the PGM may be in an oxide form (e.g., including, but not limited to, platinum or an oxide thereof). The amount of PGM(0) present can be determined using ultrafiltration, followed by Inductively Coupled Plasma/Optical Emission Spectrometry (ICP-OES), or by X-Ray photoelectron spectroscopy (XPS).

In some embodiments, the PGM comprises platinum, palladium, ruthenium, gold, or a combination thereof. In some embodiments, the PGM comprises platinum, palladium, or a combination thereof. In some embodiments, the PGM is a combination of platinum and palladium. Exemplary weight ratios for Pt/Pd combinations include weight ratios of from about 30 to about 1 Pt:Pd, for example, about 30:1, about 25:1, about 20:1, about 15:1, about 10:1, about 5:1, about 4:1, about 3:1, about 2:1, or about 1:1, Pt/Pd. In some embodiments, the Pt/Pd weight ratio is about 30:1. In some embodiments, the Pt/Pd weight ratio is about 20:1. In some embodiments, the Pt/Pd weight ratio is about 10:1. In some embodiments, the Pt/Pd weight ratio is from about 10:1 to about 1:1. In each case, the weight ratio is on an elemental (metal) basis.

In some embodiments, the PGM may be present in an amount in the range of about 0.01% to about 20% by weight on a metal basis, based on the total weight of the doped high surface area, large pore opening support material including the supported PGM. In some embodiments, the ccDOC composition may comprise, for example, Pt or Pt/Pd at from about 0.1 wt %, about 0.5 wt %, about 1.0 wt %, about 1.5 wt % or about 2.0 wt %, to about 3 wt %, about 5 wt %, about 7 wt %, about 9 wt %, about 10 wt %, about 12 wt %, about 15 wt %, about 16 wt %, about 17 wt %, about 18 wt %, about 19 wt % or about 20 wt %, based on the total weight of the doped high surface area, large pore opening support material including the supported PGM.

While the foregoing description provides several suitable ranges or amounts for the PGM and dopant of the oxidation catalyst composition, it should be noted that each disclosed range or amount for one of these components may be combined with a disclosed range or amount for the other components to form new ranges or sub-ranges. Such embodiments are also expressly contemplated by the disclosure.

### Preparation of the Oxidation Catalyst Composition

In some embodiments, the PGM and/or the dopant metal oxide may be supported on (e.g., dispersed on or impregnated in) the doped high surface area, large pore opening support material by, for example, dispersing a soluble precursor of the PGM and/or dopant metal oxide thereon. In some embodiments, the preparation of the oxidation catalyst composition as described herein comprises treating (e.g., impregnating) the high surface area, large pore opening support material in particulate form with a solution comprising a PGM precursor (e.g., a platinum and/or palladium salt) and a dopant metal oxide precursor, either individually or as a mixture. In some embodiments, the doped high surface area, large pore opening support material is prepared separately, or is obtained commercially, prior to impregnating with the PGM. The PGM may be introduced into or onto the support material by any suitable means, for example, incipient wetness, co-precipitation, or other methods known in the art. In some embodiments, a suitable method of impregnated the PGM in or disposing the PGM on the support material is to prepare a mixture of a solution of a desired PGM precursor (e.g., a platinum compound and/or a palladium compound) to produce a slurry. Non-limiting examples of suitable PGM precursors include palladium nitrate, tetraamine palladium nitrate, tetraamine platinum acetate, and platinum nitrate. In some embodiments, during the calcination steps, and/or during the initial phase of use of the composition, such compounds are converted into a catalytically active form of the metal or a compound thereof. In some embodiments, the slurry is acidic, having, for example, a pH of about 2 to less than about 7. The pH of the slurry may be lowered by the addition of an adequate amount of an inorganic acid or an organic acid to the slurry. In some embodiments, combinations of both can be used when compatibility of acid and raw materials is considered. Inorganic acids include, but are not limited to, nitric acid. Organic acids include, but are not limited to, acetic, propionic, oxalic, malonic, succinic, glutamic, adipic, maleic, fumaric, phthalic, tartaric, citric acid and the like. In some embodiments, the slurry is dried and calcined to provide the oxidation catalyst composition. In some embodiments, the PGM may be described as dispersed in, impregnated in, disposed on, or contained in the support material.

The disclosed oxidation catalyst composition may, in some embodiments, be prepared via an incipient wetness impregnation method. In some embodiments, incipient wetness impregnation techniques, also called capillary impregnation or dry impregnation, are used for the synthesis of heterogeneous materials, i.e., catalysts. In some embodiments, a metal precursor (e.g., a PGM precursor, or a dopant, or both, as disclosed herein) is dissolved in an aqueous or organic solution and then the metal-containing solution is added to the material to be impregnated (e.g., the high surface area, large pore opening support material), and which contains the same pore volume as the volume of the solution that was added. In some embodiments, capillary action draws the solution into the pores of the support material. In some embodiments, solution added in excess of the support material pore volume causes the solution transport to change from a capillary action process to a diffusion process, which is much slower. In some embodiments, the impregnated material can then be dried and calcined to remove the volatile components within the solution, depositing the active species (e.g., the PGM) on the surface of the material. In some embodiments, the maximum loading is limited by the solubility of the precursor in the solution. In some embodiments, the concentration profile of the impregnated support material depends on the mass transfer conditions within the pores during impregnation and drying.

In some embodiments, the PGM may be provided in particulate form in the oxidation catalyst composition, such as fine particles as small as 1 to 15 nanometers in diameter or smaller, as opposed to being dispersed on or impregnated in the support.

### Catalytic Articles

In some embodiments, a close-coupled diesel oxidation catalyst (ccDOC) article comprises an oxidation catalyst composition as disclosed herein. In some embodiments, the article comprises a substrate having disposed on at least a portion thereof the oxidation catalyst composition as disclosed herein. Suitable exemplary substrates are described herein below.

### Substrates

In some embodiments, the present oxidation catalyst composition is disposed on a substrate to form a catalytic article. In some embodiments, catalytic articles comprising the substrates are employed as part of an exhaust gas treatment system (e.g., catalyst articles including, but not limited to, articles including the oxidation catalyst composition disclosed herein). In some embodiments, useful substrates are 3-dimensional, having a length and a diameter and a volume, similar to a cylinder. The shape does not necessarily have to conform to a cylinder. In some embodiments, the length is an axial length defined by an inlet end and an outlet end.

In some embodiments, the substrate for the disclosed composition(s) may be constructed of any material used for preparing automotive catalysts and may comprise a metal or ceramic honeycomb structure. In some embodiments, the substrate typically provides a plurality of wall surfaces upon which the washcoat composition is applied and adhered, thereby acting as a substrate for the catalyst composition.

In some embodiments, ceramic substrates may be made of any suitable refractory material, e.g. cordierite, cordierite-α-alumina, aluminum titanate, silicon titanate, silicon carbide, silicon nitride, zircon mullite, spodumene, alumina-silica-magnesia, zircon silicate, sillimanite, a magnesium silicate, zircon, petalite, α-alumina, an aluminosilicate and the like.

In some embodiments, substrates may be metallic, comprising one or more metals or metal alloys. In some embodiments, a metallic substrate may include any metallic substrate, such as those with openings or “punch-outs” in the channel walls. In some embodiments, the metallic substrates may be employed in various shapes such as pellets, corrugated sheet or monolithic foam. Some examples of metallic substrates include heat-resistant, base-metal alloys, for example, those in which iron is a substantial or major component. In some embodiments, alloys may contain one or more of nickel, chromium, and aluminum, and the total of these metals may advantageously comprise at least about 15 wt. % (weight percent) of the alloy, for instance, about 10 to about 25 wt. % chromium, about 1 to about 8 wt. % of aluminum, and from 0 to about 20 wt. % of nickel, in each case based on the weight of the substrate. Examples of metallic substrates include, e.g., those having straight channels: those having protruding blades along the axial channels to disrupt gas flow and to open communication of gas flow between channels, and those having blades and also holes to enhance gas transport between channels allowing for radial gas transport throughout the monolith. In some embodiments, metallic substrates may be employed in a close-coupled position, allowing for fast heat-up of the substrate and, correspondingly, fast heat up of a catalyst composition coated therein (e.g., an oxidation catalyst composition).

Any suitable substrate for the catalytic articles disclosed herein may be employed, such as, for example, a monolithic substrate of the type having fine, parallel gas flow passages extending there through from an inlet or an outlet face of the substrate such that passages are open to fluid flow there through (“flow-through substrate”). In some embodiments, a suitable substrate is of the type having a plurality of fine, substantially parallel gas flow passages extending along the longitudinal axis of the substrate where, typically, each passage is blocked at one end of the substrate body, with alternate passages blocked at opposite end-faces (“wall-flow filter”). Flow-through and wall-flow substrates are also taught, for example, in International Application Publication No. WO2016/070090, which is incorporated herein by reference in its entirety.

In some embodiments, the catalyst substrate comprises a honeycomb substrate in the form of a wall-flow filter or a flow-through substrate. In some embodiments, the substrate is a wall-flow filter. Exemplary flow-through substrates and wall-flow filters will be further discussed herein below.

### Flow-Through Substrates

In some embodiments, the substrate is a flow-through substrate (e.g., monolithic substrate, including a flow-through honeycomb monolithic substrate). In some embodiments, flow-through substrates have fine, parallel gas flow passages extending from an inlet end to an outlet end of the substrate such that passages are open to fluid flow. In some embodiments, the passages, which may be essentially straight paths from their fluid inlet to their fluid outlet, are defined by walls on which a catalytic coating is disposed so that gases flowing through the passages contact the catalytic material. In some embodiments, the flow passages of the flow-through substrate are thin-walled channels, which can be of any suitable cross-sectional shape and size such as trapezoidal, rectangular, square, sinusoidal, hexagonal, oval, circular, etc. In some embodiments, the flow-through substrate can be ceramic or metallic as described above.

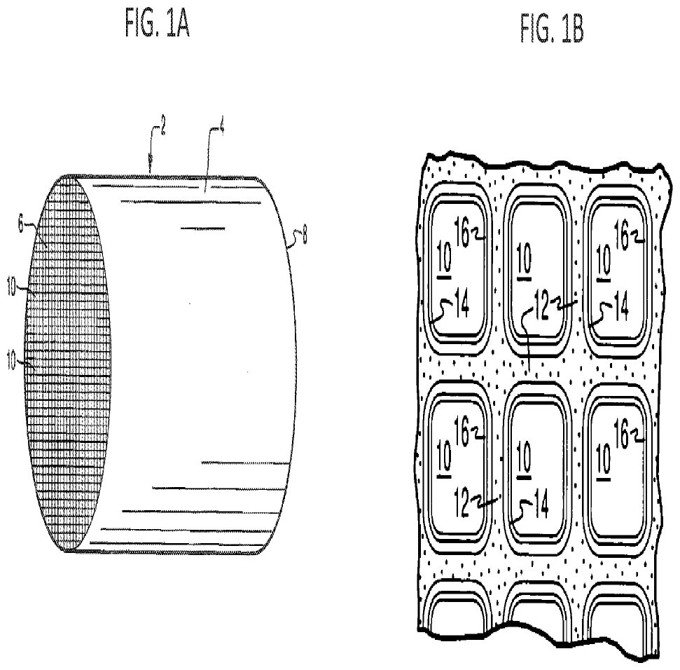

Flow-through substrates can, for example, have a volume of from about 50 in³ to about 1200 in³, a cell density (inlet openings) of from about 60 cells per square inch (cpsi) to about 500 cpsi or up to about 900 cpsi, for example from about 200 cpsi to about 400 cpsi and a wall thickness of from about 50 microns to about 200 microns or about 400 microns. FIGS. 1A and 1B illustrate an exemplary substrate 2 in the form of a flow-through substrate coated with a catalyst composition as described herein. Referring to FIG. 1A, the exemplary substrate 2 has a cylindrical shape and a cylindrical outer surface 4, an upstream end face 6 and a corresponding downstream end face 8, which is identical to end face 6. Exemplary substrate 2 has a plurality of fine, parallel gas flow passages 10 formed therein. As seen in FIG. 1B, flow passages 10 are formed by walls 12 and extend through carrier 2 from upstream end face 6 to downstream end face 8, the passages 10 being unobstructed so as to permit the flow of a fluid, e.g., a gas stream, longitudinally through carrier 2 via gas flow passages 10 thereof. As more easily seen in FIG. 1B, walls 12 are so dimensioned and configured that gas flow passages 10 have a substantially regular polygonal shape. As shown, the catalyst composition can be applied in multiple, distinct layers if desired. In the illustrated embodiment, the catalyst composition consists of both a discrete bottom layer 14 adhered to the walls 12 of the carrier member and a second discrete top layer 16 coated over the bottom layer 14. The present disclosure includes, e.g., one or more (e.g., two, three, or four or more) catalyst composition layers and is not limited to the two-layer embodiment illustrated in FIG. 1B. Further exemplary coating configurations are disclosed herein below.

### Wall-Flow Filter Substrates

In some embodiments, the substrate is a wall-flow filter, which may have a plurality of fine, substantially parallel gas flow passages extending along the longitudinal axis of the substrate. In some embodiments, each passage is blocked at one end of the substrate body, with alternate passages blocked at opposite end-faces. Such exemplary monolithic wall-flow filter substrates may contain up to about 900 or more flow passages (or “cells”) per square inch of cross-section, although far fewer may be used. For example, the substrate may have from about 7 to 600, more usually from about 100 to 400, cells per square inch (“cpsi”). The cells can have cross-sections that are rectangular, square, circular, oval, triangular, hexagonal, or are of other polygonal shapes.

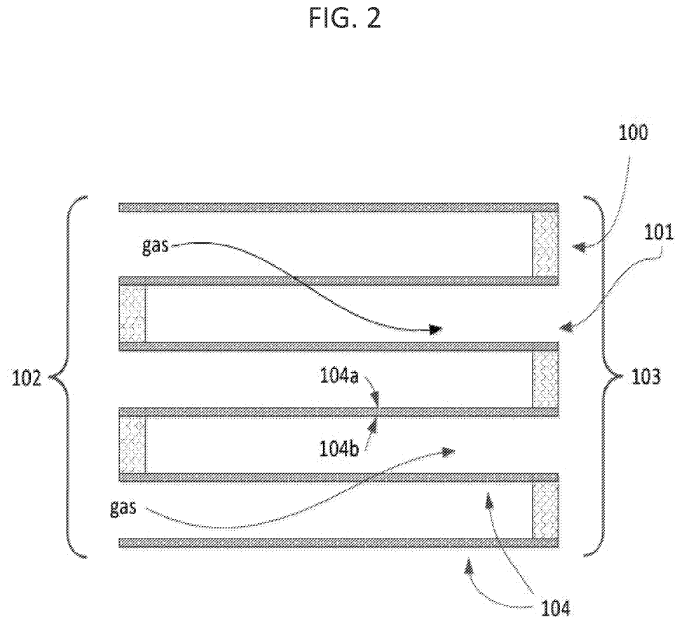

A cross-section view of an exemplary monolithic wall-flow filter substrate section is illustrated in FIG. 2, showing alternating plugged and open passages (cells). Blocked or plugged ends 100 alternate with open passages 101, with each opposing end open and blocked, respectively. The filter has an inlet end 102 and outlet end 103. The arrows crossing porous cell walls 104 represent exhaust gas flow entering the open cell ends, diffusion through the porous cell walls 104 and exiting the open outlet cell ends. Plugged ends 100 prevent gas flow and encourage diffusion through the cell walls. Each cell wall will have an inlet side 104a and outlet side 104b. The passages are enclosed by the cell walls.

In some embodiments, the wall-flow filter article substrate may have a volume of, for instance, from about 50 cm³, about 100 cm³, about 200 cm³, about 300 cm³, about 400 cm³, about 500 cm³, about 600 cm³, about 700 cm³, about 800 cm³, about 900 cm³ or about 1000 cm³ to about 1500 cm³, about 2000 cm³, about 2500 cm³, about 3000 cm³, about 3500 cm³, about 4000 cm³, about 4500 cm³ or about 5000 cm³. Wall-flow filter substrates typically have a wall thickness from about 50 microns to about 2000 microns, for example from about 50 microns to about 450 microns or from about 150 microns to about 400 microns.

In some embodiments, the walls of the wall-flow filter are porous and have a wall porosity of at least about 50% or at least about 60% with an average pore size of at least about 5 microns prior to disposition of the functional coating. For instance, the wall-flow filter article substrate in some embodiments have a porosity of ≥50%, ≥60%, ≥65% or ≥70%. For example, the wall-flow filter article substrate of some embodiments have a wall porosity of from about 50%, about 60%, about 65% or about 70% to about 75%, about 80% or about 85% and an average pore size of from about 5 microns, about 10 microns, about 20 microns, about 30 microns, about 40 microns or about 50 microns to about 60 microns, about 70 microns, about 80 microns, about 90 microns or about 100 microns prior to disposition of a catalytic coating. The terms “wall porosity” and “substrate porosity” mean the same thing and are interchangeable. Porosity is the ratio of void volume divided by the total volume of a substrate. Pore size may be determined according to ISO15901-2 (static volumetric) procedure for nitrogen pore size analysis. Nitrogen pore size may be determined on Micromeritics TRISTAR 3000 series instruments. Nitrogen pore size may be determined using BJH (Barrett-Joyner-Halenda) calculations and 33 desorption points. Useful wall-flow filters have high porosity, allowing high loadings of catalyst compositions without excessive backpressure during operation.

### Coating Compositions and Configurations

In some embodiments, to produce catalytic articles of the present disclosure, a substrate as described herein is contacted with a catalyst composition as disclosed herein to provide a coating (e.g., a slurry comprising particles of the catalyst composition are disposed on a substrate). The coatings of the oxidation catalyst composition on the substrate are referred to herein, e.g., as “catalytic coating compositions” or “catalytic coatings.” The terms “catalyst composition” and “catalytic coating composition” are synonymous.

In some embodiments, an oxidation catalyst composition as disclosed herein may be prepared using a binder, for example, a ZrO₂ binder derived from a suitable precursor such as zirconyl acetate or any other suitable zirconium precursor such as zirconyl nitrate. In some embodiments, zirconyl acetate binder provides a coating that remains homogeneous and intact after thermal aging, for example, when the catalyst is exposed to high temperatures of at least about 600° C., for example, about 800° C. and higher water vapor environments of about 5% or more. In some embodiments, binders include, but are not limited to, alumina and silica. Alumina binders include, e.g., aluminum oxides, aluminum hydroxides and aluminum oxyhydroxides. Aluminum salts and colloidal forms of alumina many also be used. Silica binders include various forms of SiO₂, including silicates and colloidal silica. In some embodiments, binder compositions include any combination of zirconia, alumina and silica. In some embodiments, binders include boehmite, gamma-alumina, or delta/theta alumina, as well as silica sol. In some embodiments, when present, the binder is used in an amount of about 1-5 wt % of the total washcoat loading. In some embodiments, the binder can be zirconia-based or silica-based, for example zirconium acetate, zirconia sol or silica sol. In some embodiments, when present, the alumina binder is used in an amount of about 0.05 g/in³ to about 1 g/in³. In some embodiments, the binder is alumina.

In some embodiments, at catalytic coating may comprise one or more coating layers, where at least one layer comprises an oxidation catalyst composition as disclosed herein. In some embodiments, a catalytic coating may comprise a single layer or multiple coating layers. In some embodiments, a catalytic coating may comprise one or more thin, adherent coating layers disposed on and in adherence to least a portion of a substrate. In some embodiments, an entire coating comprises the individual “coating layers”.

In some embodiments, catalytic articles may include the use of one or more catalyst layers and combinations of one or more catalyst layers. In some embodiments, catalytic materials may be present on the inlet side of the substrate wall alone, the outlet side alone, both the inlet and outlet sides, or the wall itself may consist all, or in part, of the catalytic material. In some embodiments, a catalytic coating may be on the substrate wall surfaces and/or in the pores of the substrate walls, that is “in” and/or “on” the substrate walls. Thus, the phrase “a catalytic coating disposed on the substrate” means on any surface, for example on a wall surface and/or on a pore surface.

In some embodiments, catalyst compositions may be applied in the form of a washcoat, containing support material having catalytically active species thereon. In some embodiments, a washcoat is formed by preparing a slurry containing a specified solids content (e.g., about 10% to about 60% by weight) of supports in a liquid vehicle, which is then applied to a substrate and dried and calcined to provide a coating layer. In some embodiments, if multiple coating layers are applied, the substrate is dried and calcined after each layer is applied and/or after the number of desired multiple layers are applied. In some embodiments, the catalytic material(s) are applied to the substrate as a washcoat. In some embodiments, binders may also be employed as described above.

In some embodiments, catalyst composition(s) are independently mixed with water to form a slurry for purposes of coating a catalyst substrate, such as a honeycomb-type substrate. In some embodiments, in addition to the catalyst particles, the slurry may optionally contain a binder (e.g., alumina, silica), water-soluble or water-dispersible stabilizers, promoters, associative thickeners, and/or surfactants (including anionic, cationic, non-ionic or amphoteric surfactants). In some embodiments, the pH range for the slurry is about 3 to about 6. Addition of acidic or basic species to the slurry can be carried out to adjust the pH accordingly. For example, in some embodiments, the pH of the slurry is adjusted by the addition of ammonium hydroxide or aqueous nitric acid.

In some embodiments, the slurry can be milled to enhance mixing of the particles and formation of a homogenous material. In some embodiments, milling is accomplished in a ball mill, continuous mill, or other similar equipment, and the solids content of the slurry may be, e.g., about 20 wt. % to about 60 wt. %, more particularly about 20 wt. % to about 40 wt. %. In some embodiment, the post-milling slurry is characterized by a D₉₀ particle size of about 10 to about 40 microns, such as 10 microns to about 30 microns, for example about 10 microns to about 15 microns.

The slurry is then coated on the catalyst substrate using any washcoat technique known in the art. In some embodiment, the catalyst substrate is dipped one or more times in the slurry or otherwise coated with the slurry. Thereafter, in some embodiments, the coated substrate is dried at an elevated temperature (e.g., 100° C. to 150° C.) for a period of time (e.g., 10 min-3 hours) and then calcined by heating, e.g., at 400° C. 600° C., in some embodiments, for about 10 minutes to about 3 hours. Following drying and calcining, the final washcoat coating layer can be viewed as essentially solvent-free.

In some embodiments, after calcining, the catalyst loading obtained by the above described washcoat technique can be determined through calculation of the difference in coated and uncoated weights of the substrate. As will be apparent to those of skill in the art, the catalyst loading can be modified, in some embodiments, by altering the slurry rheology. In some embodiments, the coating/drying/calcining process to generate a washcoat can be repeated as needed to build the coating to the desired loading level or thickness, meaning more than one washcoat may be applied.

In some embodiments, the washcoat(s) can be applied such that different coating layers may be in direct contact with the substrate. In some embodiments, one or more “undercoats” may be present, so that at least a portion of a catalytic or sorbent coating layer or coating layers are not in direct contact with the substrate (but rather, are in contact with the undercoat). In some embodiments, one or more “overcoats” may also be present, so that at least a portion of the coating layer or layers are not directly exposed to a gaseous stream or atmosphere (but rather, are in contact with the overcoat). In some embodiments, the catalyst composition may be in a bottom layer over a substrate.

In some embodiments, the catalyst composition may be in a top coating layer over a bottom coating layer. In some embodiments, the catalyst composition may be present in a top and a bottom layer. In some embodiments, any one layer may extend the entire axial length of the substrate, for instance a bottom layer may extend the entire axial length of the substrate and a top layer may also extend the entire axial length of the substrate over the bottom layer. In some embodiments, each of the top and bottom layers may extend from either the inlet or outlet end.

For example, both bottom and top coating layers may extend from the same substrate end where the top layer partially or completely overlays the bottom layer and where the bottom layer extends a partial or full length of the substrate and where the top layer extends a partial or full length of the substrate. In some embodiments, a top layer may overlay a portion of a bottom layer. For example, a bottom layer may extend the entire length of the substrate and the top layer may extend from about 10%, about 20%, about 30%, about 40%, about 50%, about 60%, about 70%, about 80% or about 90% of the substrate length, from either the inlet or outlet end.

In some embodiments, a bottom layer may extend from about 10%, about 15%, about 25%, about 30%, about 40%, about 45%, about 50%, about 55%, about 60%, about 65%, about 70%, about 75%, about 80%, about 85% or about 95% of the substrate length from either the inlet end or outlet end and a top layer may extend about 10%, about 15%, about 25%, about 30%, about 40%, about 45%, about 50%, about 55%, about 60%, about 65%, about 70%, about 75%, about 80%, about 85% or about 95% of the substrate length from either the inlet end of outlet end, wherein at least a portion of the top layer overlays the bottom layer. This “overlay” zone may for example extend from about 5% to about 80% of the substrate length, for example about 5%, about 10%, about 20%, about 30%, about 40%, about 50%, about 60% or about 70% of the substrate length.

In some embodiments, top and/or bottom coating layers may be in direct contact with the substrate. In some embodiments, one or more “undercoats” may be present, so that at least a portion of the top and/or the bottom coating layers are not in direct contact with the substrate (but rather with the undercoat). In some embodiments, one or more “overcoats” may also be present, so that at least a portion of the top and/or bottom coating layers are not directly exposed to a gaseous stream or atmosphere (but rather are in contact with the overcoat). In some embodiments, an undercoat is a layer “under” a coating layer, an overcoat is a layer “over” a coating layer and an interlayer is a layer “between” two coating layers.

In some embodiments, the top and bottom coating layers may be in direct contact with each other without any interlayer. In some embodiments, different coating layers may not be in direct contact, with a “gap” between the two zones. In some embodiments, an interlayer, if present, may prevent the top and bottom layers from being in direct contact. In some embodiments, an interlayer may partially prevent the top and bottom layers from being in direct contact and thereby allow for partial direct contact between the top and bottom layers. In some embodiments, the interlayer(s), undercoat(s) and overcoat(s) may contain one or more catalysts or may be free of catalysts. In some embodiments, the present catalytic coatings may comprise more than one identical layers, for instance more than one layer containing identical catalyst compositions.

In some embodiments, the catalytic coating may advantageously be “zoned,” comprising zoned catalytic layers, that is, where the catalytic coating contains varying compositions across the axial length of the substrate. This may also be described as “laterally zoned”. For example, a layer may extend from the inlet end towards the outlet end extending from about 10%, about 20%, about 30%, about 40%, about 50%, about 60%, about 70%, about 80%, or about 90% of the substrate length. Another layer may extend from the outlet end towards the inlet end extending from about 10%, about 20%, about 30%, about 40%, about 50%, about 60%, about 70%, about 80%, or about 90% of the substrate length. In some embodiments, different coating layers may be adjacent to each other and not overlay each other. In some embodiments, different layers may overlay a portion of each other, providing a third “middle” zone. The middle zone may, for example, extend from about 5% to about 80% of the substrate length, for example about 5%, about 10%, about 20%, about 30%, about 40%, about 50%, about 60% or about 70% of the substrate length.

In some embodiments, different layers may each extend the entire length of the substrate or may each extend a portion of the length of the substrate and may overlay or underlay each other, either partially or entirely. In some embodiments, each of the different layers may extend from either the inlet or outlet end. In some embodiments, different catalytic compositions may reside in each separate coating layer. In some embodiments, the catalytic coatings may comprise more than one identical layer.

Zones of the present disclosure are defined by the relationship of coating layers. With respect to different coating layers, there are a number of possible zoning configurations. For example, there may be an upstream zone and a downstream zone, there may be an upstream zone, a middle zone and a downstream zone, there may four different zones, etc. Where two layers are adjacent and do not overlap, there are upstream and downstream zones. Where two layers overlap to a certain degree, there are upstream, downstream and middle zones. Where for example, a coating layer extends the entire length of the substrate and a different coating layer extends from the outlet end a certain length and overlays a portion of the first coating layer, there are upstream and downstream zones.

In some embodiments, first and second coating layers may be overlaid, either first over second or second over first (i.e. top/bottom), for example where the first coating layer extends from the inlet end towards the outlet end and where the second coating layer extends from the outlet end towards the inlet end. In this case, the catalytic coating will comprise an upstream zone, a middle (overlay) zone and a downstream zone. The first and/or second coating layers may be synonymous with the above top and/or bottom layers described above.

In some embodiment, a first coating layer may extend from the inlet end towards the outlet end and a second coating layer may extend from the outlet end towards the inlet end, where the layers do not overlay each other, for example they may be adjacent.

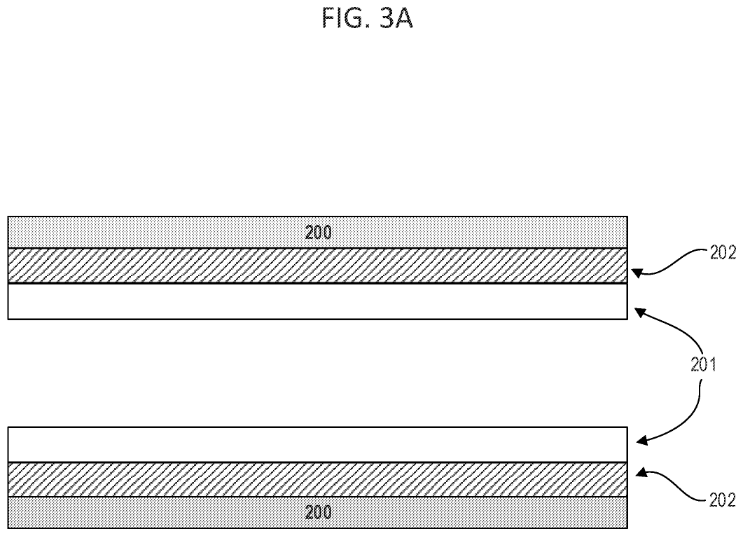

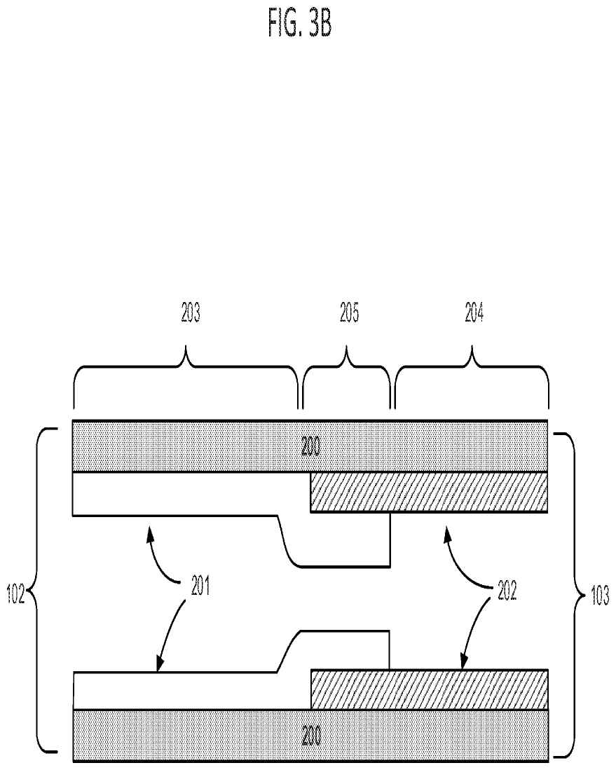

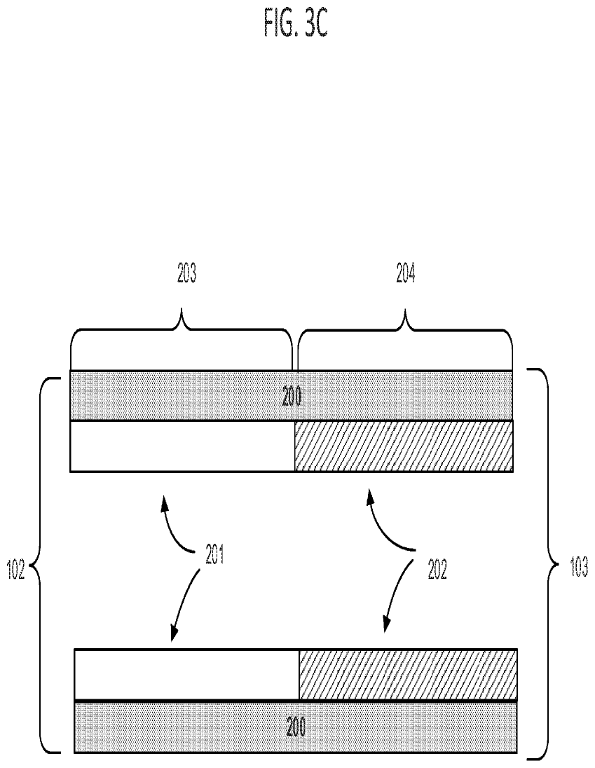

FIGS. 3A, 3B, and 3C show some possible coating layer configurations with two coating layers, wherein at least one of said coating layers comprises the catalyst composition as disclosed herein. Shown are substrate walls 200 onto which coating layers 201 (top coat) and 202 (bottom coat) are disposed. These are simplified exemplary illustrations, and in the case of a porous wall-flow substrate, not shown are pores and coatings in adherence to pore walls and not shown are plugged ends. In FIG. 3A, coating layers 201 and 202 each extend the entire length of the substrate with top layer 201 overlaying bottom layer 202. The substrate of FIG. 3A does not contain a zoned coating configuration. In FIG. 3B, bottom coating layer 202 extends from the outlet about 50% of the substrate length and top coating layer 201 extends from the inlet greater than 50% of the length and overlays a portion of layer 202, providing an upstream zone 203, a middle overlay zone 205 and a downstream zone 204. In FIG. 3C, coating layer 202 extends from the outlet about 50% of the substrate length and coating layer 201 extends from the inlet greater than 50% of the length and overlays a portion of layer 202, providing an upstream zone 203, a middle overlay zone 205, and a downstream zone 204. FIGS. 3A, 3B, and 3C may be useful to illustrate coating compositions on a wall-through substrate or the flow-through substrate.

In some embodiments, the oxidation catalytic coating, as well as any zone or any layer or any section of a coating, is present on the substrate at a loading (concentration) of for example from about 0.3 g/in³ to about 6.0 g/in³, or from about 0.4, about 0.5, about 0.6, about 0.7, about 0.8, about 0.9 or about 1.0 g/in³ to about 1.5 g/in³, about 2.0 g/in³, about 2.5 g/in³, about 3.0 g/in³, about 3.5 g/in³, about 4.0 g/in³, about 4.5 g/in³, about 5.0 g/in³ or about 5.5 g/in³, based on the volume of the substrate.

This refers to dry solids weight per volume of substrate, for example per volume of a honeycomb monolith. Concentration is based on a cross-section of a substrate or on an entire substrate. In some embodiments, a top coating layer is present at a lower loading than the bottom coating layer.

In some embodiments, the loading of the PGM of the disclosed oxidation catalyst composition on the substrate may be in the range from about 2 g/ft³, about 5 g/ft³, or about 10 g/ft³ to about 250 g/ft³, for example from about 20 g/ft³, about 30 g/ft³, about 40 g/ft³, about 50 g/ft³ or about 60 g/ft³ to about 100 g/ft³, about 150 g/ft³ or about 200 g/ft³, about 210 g/ft³, about 220 g/ft³, about 230 g/ft³, about 240 g/ft³ or about 250 g/ft³, based on the volume of the substrate. In some embodiments, the PGM is for example present in a catalytic layer from about 0.1 wt %, about 0.5 wt %, about 1.0 wt %, about 1.5 wt % or about 2.0 wt % to about 3 wt %, about 5 wt %, about 7 wt %, about 9 wt %, about 10 wt %, about 12 wt % or about 15 wt %, based on the weight of the layer.

### Exhaust Gas Treatment Systems

In some embodiments is a system for treatment of an exhaust gas stream from an internal combustion engine containing hydrocarbons (HCs), carbon monoxide (CO), and nitrogen oxides (NOₓ). In some embodiments, the system comprises a close-coupled diesel oxidation catalyst (ccDOC) article located downstream of the internal combustion engine, the ccDOC article comprising a substrate as described herein, and the oxidation catalyst composition as described herein, disposed on at least a portion of the substrate. In some embodiments, the ccDOC article is configured for use in a close-coupled position, meaning it is located downstream from and in close proximity to an engine producing an exhaust stream, and is in fluid communication with the exhaust stream. In some embodiments, the ccDOC article is operative at a space velocity of 150,000 h⁻¹ or greater to light off HCs at a temperature below about 200° C., rapidly raising the temperature of the exhaust gas exiting the ccDOC article.

In some embodiments, the system further comprises one or more catalytic articles positioned downstream from the ccDOC and in fluid communication with the exhaust gas stream exiting the ccDOC. In some embodiments, the relative placement of the various catalytic components present within the emission treatment system can vary. In some embodiments, the engine can be, e.g., a diesel engine which operates at combustion conditions with air in excess of that required for stoichiometric combustion, i.e. lean conditions. In some embodiments, the engine can be an engine associated with a stationary source (e.g., electricity generators or pumping stations). In some embodiments, as referenced above, use of a ccDOC is particularly advantageous in combination with a downstream SCR catalyst. In some embodiments, the ccDOC serves to promote SCR performance at the low temperature end of the spectrum by heating up the exhaust gas entering the SCR quickly, so that SCR can be functioning before the total NOx emissions exceed the permissible amount under current regulations.

In some embodiments of the exhaust gas treatment systems and methods, the exhaust gas stream is received into the article(s) or treatment system by entering the upstream end and exiting the downstream end. In some embodiments, the inlet end of a substrate or article is synonymous with the “upstream” end or “front” end. In some embodiments, the outlet end is synonymous with the “downstream” end or “rear” end. In some embodiments, the treatment system is, in general, downstream of and in fluid communication with an internal combustion engine.

In some embodiments, a system contains more than one article, for instance, a diesel oxidation catalyst (DOC) and one or more articles containing a reductant injector, a selective catalytic reduction catalyst (SCR), a soot filter, an ammonia oxidation catalyst (AMOx) or a lean NOx trap (LNT). In some embodiments, an article containing a reductant injector is a reduction article. In some embodiments, a reduction system includes a reductant injector and/or a pump and/or a reservoir, etc.

In some embodiments, the treatment system may further comprise a selective catalytic reduction catalyst and/or a soot filter and/or an ammonia oxidation catalyst. In some embodiments, a soot filter may be uncatalyzed or may be catalyzed (CSF). For example, the treatment system may comprise, from upstream to downstream—a ccDOC article as disclosed herein, a DOC, a CSF, a urea injector, a SCR article and an article containing an AMOx. A lean NOx trap (LNT) may also be included. In some embodiments, such articles may be on separate substrates, or may be layered or zoned on a single substrate in various combinations. In some embodiments, one or more of the DOC, CSF, SCR, LNT, and AMOx may be combined within a single article, or may be present as discrete articles.

In some embodiments, the system further comprises a second diesel oxidation catalyst (DOC) article located downstream of the engine and downstream of the ccDOC, and adapted for oxidation of HCs, CO and NOx. In some embodiments, a suitable DOC for use in the emission treatment system is able to effectively catalyze the oxidation of CO and HC to carbon dioxide (CO₂). In some embodiments, the DOC is capable of converting at least 50% of the CO or HC component present in the exhaust gas. In some embodiments, the DOC typically does not comprise an oxidation catalyst composition as uniquely provided herein; rather, conventional DOC catalyst compositions can be advantageously employed, such as those including one or more platinum group metals (e.g., palladium and/or platinum), a support material such as alumina, zeolites for HC storage, and optionally promoters and/or stabilizers. In some embodiments, suitable DOC catalyst compositions are described in, for example, U.S. Pat. No. 10,335,776, and U.S. Patent Application Publication Ser. No. 16/170,406, each of which is incorporated herein by reference in its entirety.

In addition to treating the exhaust gas emissions via use of a DOC, emission treatment systems may employ a soot filter for removal of particulate matter. The soot filter may be located upstream or downstream from the DOC, but typically, the soot filter will be located downstream from the DOC. In some embodiments, the soot filter is a catalyzed soot filter (CSF). In some embodiments, the CSF may comprise a substrate coated with washcoat particles containing one or more catalysts for burning trapped soot and or oxidizing exhaust gas stream emissions. In some embodiments, the soot burning catalyst can be any known catalyst for combustion of soot. For example, the CSF can be coated with one or more high surface area refractory oxides (e.g., an aluminum oxide or ceria-zirconia) for the combustion of CO and unburned hydrocarbons and to some degree particulate matter. In some embodiments, the soot burning catalyst can be an oxidation catalyst comprising one or more precious metal catalysts (e.g., platinum and/or palladium).

In some embodiments, the system further comprises a selective catalytic reduction (SCR) article adapted for the reduction of nitrogen oxides (NOₓ), wherein all catalyst articles are in fluid communication with the exhaust gas stream. In some embodiments, the SCR catalyst article may be located upstream or downstream of the DOC and/or soot filter. In some embodiments, a suitable SCR catalyst component for use in the emission treatment system is able to effectively catalyze the reduction of the NOₓ exhaust component at temperatures as high as 650° C. In some embodiments, the SCR catalyst component is active for reduction of NOₓ even under conditions of low load which typically are associated with lower exhaust temperatures. In some embodiments, the SCR catalyst article is capable of converting at least 50% of the NOₓ (e.g., NO) component to N₂, depending on the amount of reductant added to the system. In some embodiments, suitable SCR catalysts are described, for instance, in U.S. Pat. Nos. 4,961,917 and 5,516,497, each of which is incorporated herein by reference in its entirety.

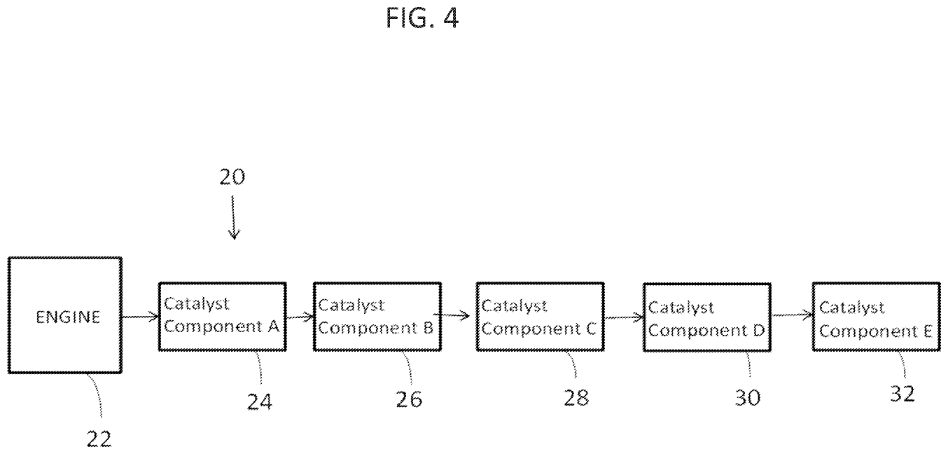

One exemplary emission treatment system is illustrated in FIG. 4, which depicts a schematic representation of an emission treatment system 20. As shown, the emission treatment system can include a plurality of catalyst components in series downstream of an engine 22, such as a lean burn engine. At least one of the catalyst components will comprise the oxidation catalyst composition of the disclosure as set forth herein (e.g., a ccDOC). FIG. 4 illustrates five catalyst components, 24, 26, 28, 30, 32 in series; however, the total number of catalyst components can vary and five components is merely one example.

Without limitation, Table 1 presents various exhaust gas treatment system configurations of one or more embodiments. It is noted that each catalyst is connected to the next catalyst via exhaust conduits such that the engine is upstream of catalyst A, which is upstream of catalyst B, which is upstream of catalyst C, which is upstream of catalyst D, which is upstream of catalyst E (when present). The reference to Components A-E in the table can be cross-referenced with the same designations in FIG. 4.

The LNT catalyst noted in Table 1 can be any catalyst conventionally used as a NOₓ trap, and typically comprises NOₓ adsorber compositions that include base metal oxides (BaO, MgO, CeO₂, and the like) and a platinum group metal for catalytic NO oxidation and reduction (e.g., Pt and/or Rh).

Reference to SCR in the table refers to an SCR catalyst. Reference to SCRoF (or SCR on filter) refers to a particulate or soot filter (e.g., a wall-flow filter), which can include an SCR catalyst composition. In uncatalyzed form, such a particulate filter may be referred to as a diesel particulate filter (DPF).

Reference to AMOx in the table refers to an ammonia oxidation catalyst, which can be provided downstream of the catalyst of some embodiments of the disclosure to remove any slipped ammonia from the exhaust gas treatment system. AMOx is used synonymously with ammonia slip catalyst (ASC). In some embodiments, the AMOx catalyst may comprise a PGM component. In some embodiments, the AMOx catalyst may comprise a bottom coat comprising one or more PGMs and a top coat with SCR functionality.

As recognized by one skilled in the art, in the configurations listed in Table 1, any one or more of components A, B, C, D, or E can be disposed on a particulate filter, such as a wall flow filter, or on a flow-through honeycomb substrate. In some embodiments, an engine exhaust system comprises one or more catalyst compositions mounted in a position near the engine (in a close-coupled position, cc), with additional catalyst compositions in a position underneath the vehicle body (in an underfloor position, UF). In some embodiments, the exhaust gas treatment system may further comprise a urea injection component (typically upstream of the SCR component).

TABLE 1
Possible exhaust gas treatment system configurations

| Component | Component | Component | Component | Component |
|---|---|---|---|---|
| A | B | C | D | E |
| ccDOC | DOC | CSF | SCR | Optional |
| | | | | AMOx |
| ccDOC | CSF | DOC | SCR | Optional |
| | | | | AMOx |
| ccDOC | DOC | DPF | SCR | Optional |
| | | | | AMOx |
| ccDOC | DOC | SCR | CSF | Optional |
| | | | | AMOx |

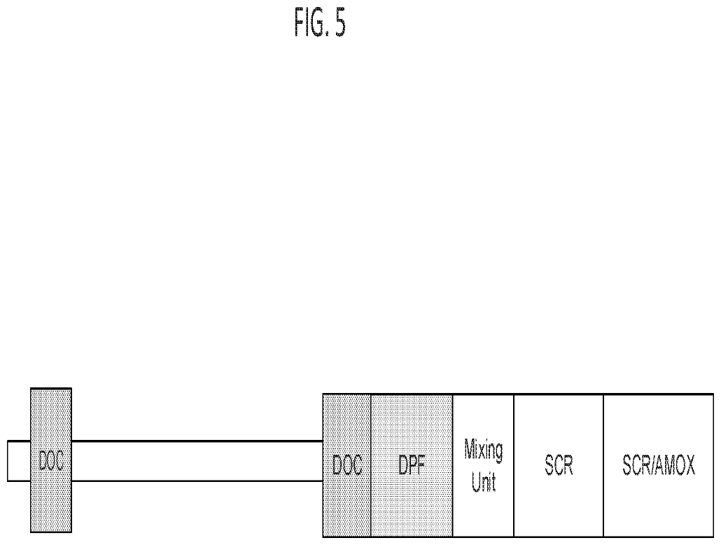

In some embodiment, the system comprises a close coupled diesel oxidation catalyst (ccDOC) article located downstream of the internal combustion engine, the ccDOC article comprising a substrate, and the oxidation catalyst composition as disclosed herein, disposed on at least a portion of the substrate: a diesel oxidation catalyst (DOC) article located downstream of the engine and downstream of the ccDOC and adapted for oxidation of HCs, CO and NOx; and a selective catalytic reduction (SCR) article adapted for the reduction of nitrogen oxides (NOₓ), located downstream of the DOC article; wherein all catalyst articles are in fluid communication with the exhaust gas stream. In some embodiments, the system further comprises a soot filter, which may be catalyzed or not, and an AMOx. In some embodiments, the system comprises a ccDOC as described herein, a DOC article located downstream of the ccDOC, a diesel particulate filter located downstream of the DOC, a mixer configured to introduce and mix ammonia or an ammonia precursor with the exhaust gas stream, an SCR catalyst comprising an upstream iron-promoted zeolite and a downstream copper promoted zeolite, and an AMOx located downstream from the SCR, wherein all catalyst articles are in fluid communication with the exhaust gas stream. A graphical depiction of such a system is provided in FIG. 5.

### Method of Treating an Exhaust Gas Stream

In some embodiments is a method for treating a lean burn engine exhaust gas stream, the method comprising contacting the exhaust gas stream with the emission treatment system of the present disclosure. In some embodiments, hydrocarbons (HCs) and carbon monoxide (CO) present in the exhaust gas stream of any engine can be converted to carbon dioxide and water in the ccDOC, the DOC, or both. In some embodiments, hydrocarbons present in an engine exhaust gas stream comprise C₁-C₆ hydrocarbons (i.e., lower hydrocarbons), such as methane, although higher hydrocarbons (greater than C₆) can also be detected.

In some embodiments is a method for reducing HCs, CO, and NOₓ present in an exhaust gas stream from an internal combustion engine, the method comprising: introducing a quantity of HCs into the exhaust stream to form an exhaust gas stream enriched in HCs; contacting the HC-enriched exhaust gas stream with the oxidation catalyst composition as disclosed herein, wherein the oxidation catalyst composition is disposed on a substrate, positioned downstream of the internal combustion engine in a close-coupled position, to generate an exotherm by combustion of the HCs, thereby forming a heated, first effluent; contacting the heated, first effluent with a diesel oxidation catalyst adapted for the oxidation of HCs, CO and NO, thereby forming a second effluent with reduced levels of HCs and CO and elevated levels of NO₂; injecting a reductant into the second effluent exiting the diesel oxidation catalyst to obtain a third effluent; and contacting the third effluent with a SCR catalyst adapted for the reduction of NOₓ, thereby forming a treated exhaust gas stream with reduced levels of HCs, CO, and NOₓ.

In some embodiments, catalyst compositions, articles, systems, and methods disclosed herein are suitable for treatment of exhaust gas streams of internal combustion engines, for example gasoline, light-duty diesel and heavy duty diesel engines. In some embodiments, the catalyst compositions are also suitable for treatment of emissions from stationary industrial processes. In some embodiments, the internal combustion engine is a diesel engine. In some embodiments, the internal combustion engine is a light duty or a heavy duty diesel engine.

It will be readily apparent to one of ordinary skill in the relevant arts that suitable modifications and adaptations to the compositions, methods, and applications described herein can be made without departing from the scope of any embodiments or aspects thereof. The compositions and methods provided are exemplary and are not intended to limit the scope of the claimed embodiments. All of the various embodiments, aspects, and options disclosed herein can be combined in all variations. The scope of the compositions, formulations, methods, and processes described herein include all actual or potential combinations of embodiments, aspects, options, examples, and preferences herein. All patents and publications cited herein are incorporated by reference herein for the specific teachings thereof as noted, unless other specific statements of incorporation are specifically provided.

### EXAMPLES

The present disclosure is more fully illustrated by the following examples, which are set forth to illustrate the present disclosure and is not to be construed as limiting thereof. Unless otherwise noted, all parts and percentages are by weight, and all weight percentages are expressed on a dry basis, meaning excluding water content, unless otherwise indicated.

### Example 1: 2% Pt on Alumina Support (Reference)

A reference sample (2% Pt on alumina) was prepared. A high surface area (surface area of 150 m²/g), small pore (average pore opening of less than about 15 nm) refractory alumina support was added into a Pt compound solution (prepared according to the method disclosed in US2017/0304805; incorporated by reference herein) to prepare a slurry with about 30% solids concentration. This slurry was then milled for 10 minutes until the D₉₀ was less than 20 microns. The milled powder then dried and calcined at 590° C. The resulting dry powder was divided into two portions. The first portion was used as is (“fresh”), and the second portion was aged in air with 10% steam for 20 hours at 650° C. (“aged”).

### Example 2: 2% Pt on Silica-Alumina Support (Reference)

A reference sample (2% Pt on silica-alumina) was prepared. A high surface area (surface area of 150 m²/g), small pore (average pore opening of less than about 15 nm) refractory alumina support doped with 5% silica was added into a Pt compound solution (prepared according to the method disclosed in US2017/0304805; incorporated by reference herein) to prepare a slurry with about 30% solids concentration. This slurry was then milled for 10 minutes until the D₉₀ was less than 20 microns. The milled powder then dried and calcined at 590° C. The resulting dry powder was divided into two portions. The first portion was used as is (“fresh”), and the second portion was aged in air with 10% steam for 20 hours at 650° C. (“aged”).

### Example 3: 2% Pt on 5% Titania-Alumina Support (Inventive)

An inventive sample (2% Pt on 5% titania-alumina) was prepared using the method of Example 1, but substituting a high surface area (surface area of 150 m²/g), small pore (average pore opening of less than about 15 nm) refractory alumina support doped with 5% titania for the alumina.

### Example 4: 2% Pt on 10% Titania-Alumina Support (Inventive)

An inventive sample (2% Pt on 10% titania-alumina) was prepared using the method of Example 1, but substituting a low surface area (surface area of ˜80 m²/g), large pore (average pore opening of about 25 nm) refractory alumina support doped with 10% titania for the alumina.

### Example 5: 2% Pt on 4% Lanthana-Alumina Support (Reference)

A reference sample (2% Pt on 4% lanthana-alumina) was prepared using the method of Example 1, but substituting a low surface area (surface area of ˜80 m²/g), large pore (average pore opening of about 50 nm) refractory alumina support doped with 4% lanthana for the alumina.

### Example 6: 2% Pt on 4% Zirconia-Alumina Support (Inventive)

A reference sample (2% Pt on 4% zirconium-alumina) was prepared using the method of Example 1, but substituting a high surface area (surface area of 150 m²/g), small pore (average pore opening of less than about 15 nm) refractory alumina support doped with 4% zirconia for the alumina.

### Example 7: 2% Pt on 5% Manganese-Alumina Support (Inventive)

A reference sample (2% Pt on 5% manganese-alumina) was prepared using the method of Example 1, but substituting a high surface area (surface area of about 150 m²/g), large pore (average pore opening of about 23 nm) refractory alumina support doped with 5% manganese oxide for the alumina.

### Example 8: 2% Pt on Large-Pore Alumina Support (Inventive)

An inventive sample (2% Pt on large-pore alumina) was prepared using the method of Example 1, but substituting the alumina of Example 1 with a large pore alumina having an average pore opening of 40 nm and a surface area of 90 m²/g.

### Example 9: Reactor Testing Light-Off Experiments

Powder samples of Examples 1-8 were evaluated for hydrocarbon light-off in a reactor under steady-state and continuous ramp-up conditions, with and without nitric oxide (NO) in the feed. The catalysts were first dehydrated under an argon atmosphere at 400° C. for 1 hour at a flow rate of 100 ml/min. The gas feed was propylene (C₃Hs) at 500 ppm and oxygen (O₂) at 10%, with and without NO (500 ppm when present). Continuous light-off was monitored from 120-250° C. at a ramp of 10° C./minute. For steady-state light-off, a stepwise 5-minute soak at 5 different temperatures (150° C., 180° C., 200° C., 220° C. and 250° C.) was used.

The propylene light-off reaction was investigated in an Operando spectroscopy unit. The Operando unit consisted of a Linkam CCR1000 powder-bed flow-through reactor equipped with a calcium fluoride (CaF₂) window, which allowed performance of infrared spectroscopy measurements of the catalysts under working conditions. A Hidden Analytical Mass Spectrometer (MS) and an FT-IR gas cell analyzer—MKS MultiGas were used to monitor the gas phase components in the exhaust of the Operando reactor.

The effluent gas temperature from a ccDOC is the critical factor in determining performance of the ccDOC As the effluent temperature is determined by the exotherm generated by the hydrocarbon (HC) combustion, the CO₂ formation rate, rather than the HC conversion rate, is a better gauge by which to measure the catalyst performance. Specifically, the feed HC gas (e.g., propylene) may form polymeric substances (graphite based coke, etc.), which may contribute to HC conversion which is not useful in the ccDOC application. Accordingly, HC light-off was evaluated using CO₂ formation rate as the performance criterion.

### Example 10. Diffuse Reflectance Infrared Fourier Transform Spectroscopy (DRIFTS) Experiments

Powder samples of Examples 1-8 were evaluated by DRIFTS experiments during the Operando studies. DRIFTS experiments were carried out on an Agilent CARY680 FTIR spectrometer equipped with a mercury cadmium telluride (MCT-HgCdTe) detector and the Linkam CCR1000 high-temperature environmental chamber with a calcium fluoride (CaF₂) window. The sample powders were dehydrated in flowing Ar at 40° C. for 1 hour at a flow rate of 100 ml/min. The DRIFTS were collected during the Operando reactions carried out at various temperatures. The absorbance spectra from the DRIFTS were extracted for analysis after subtraction of the background spectrum.

### Example 11. Results

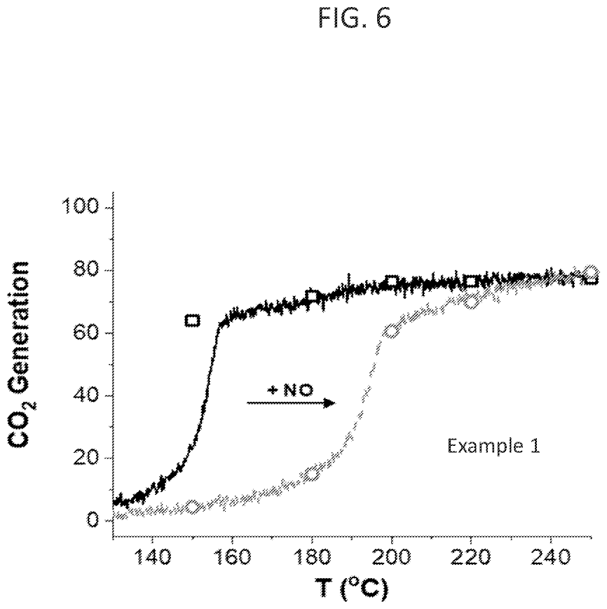

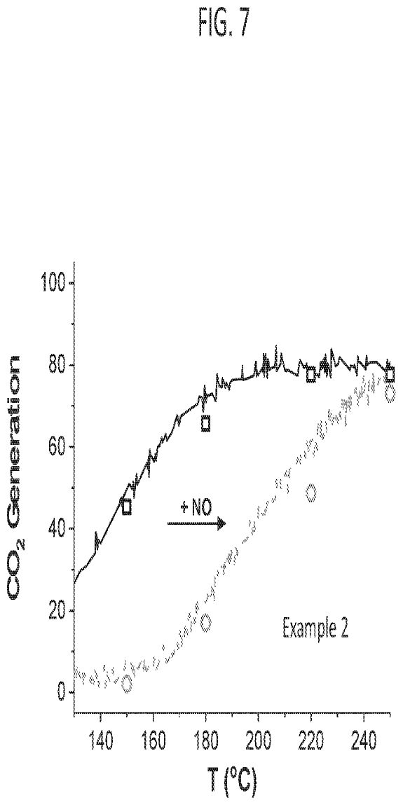

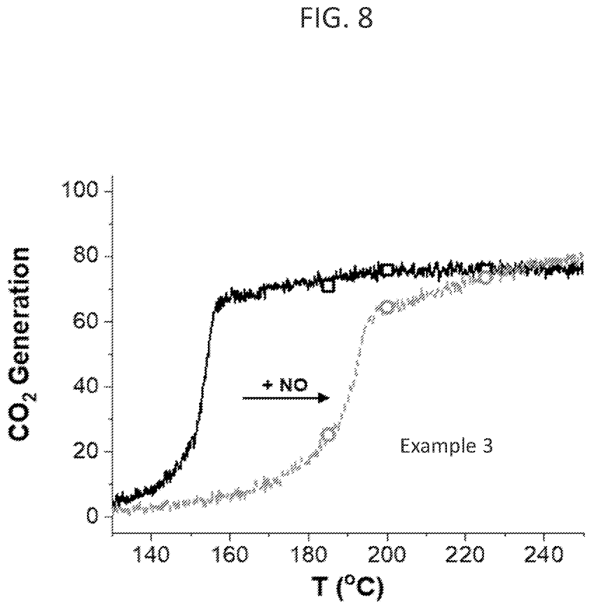

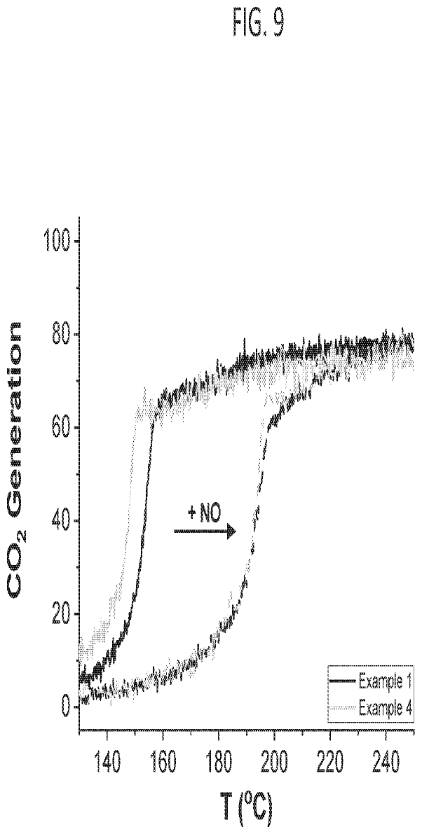

The Operando results demonstrated that the continuous ramp up experiments generated similar results to the steady state experiments for the two reference articles (Examples 1 & 2; FIGS. 6 and 7, respectively). Results shown in FIG. 8 indicated that the light-off performance of inventive Example 3 was faster than both reference samples (Examples 1 & 2).

To further illustrate the benefits from the addition of Ti onto the alumina support, a comparison between reference Example 1 and inventive Example 4 was plotted (FIG. 9), which clearly illustrated the quick light-off phenomena generated by the addition of Ti on the alumina support (a sharper temperature rise slope).

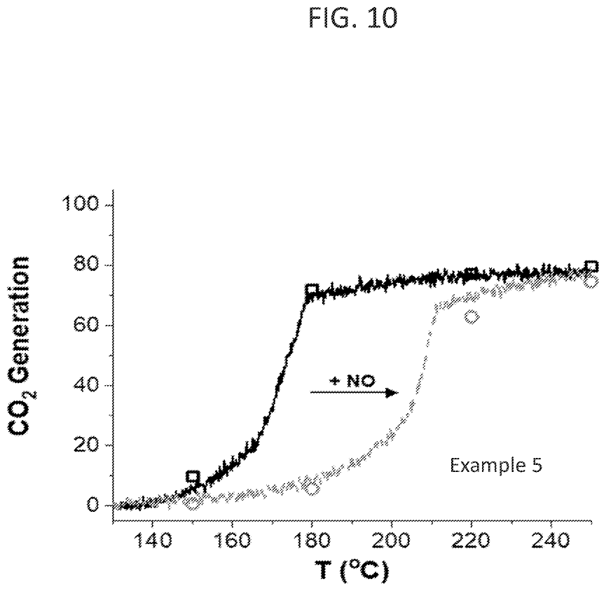

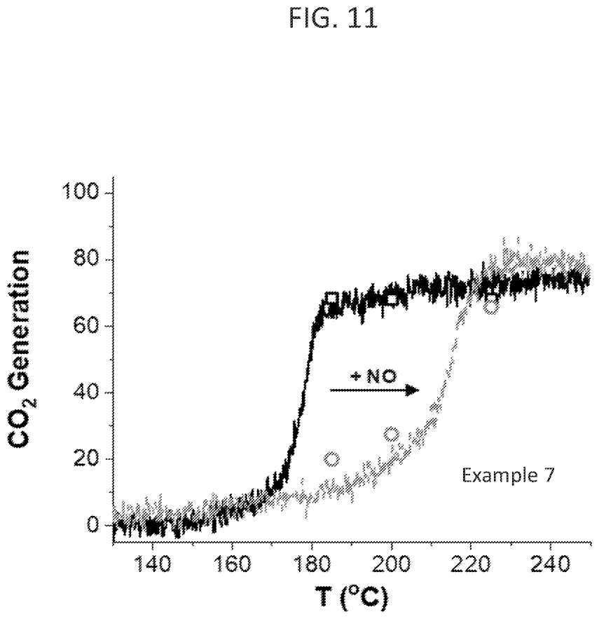

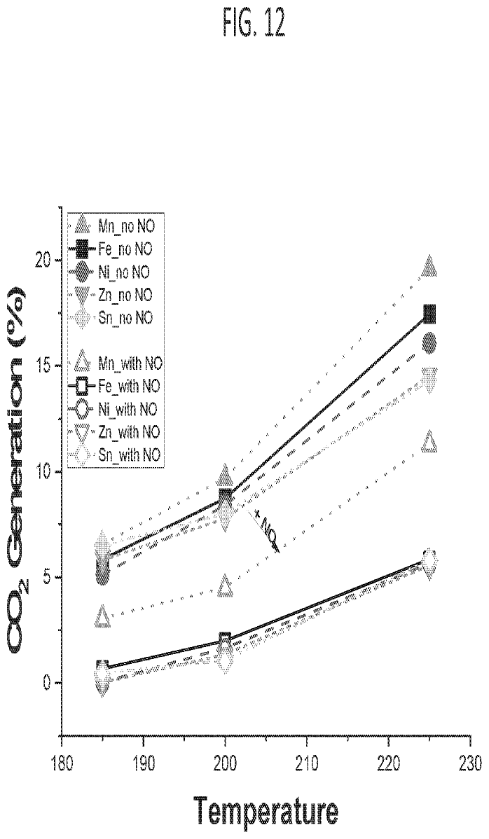

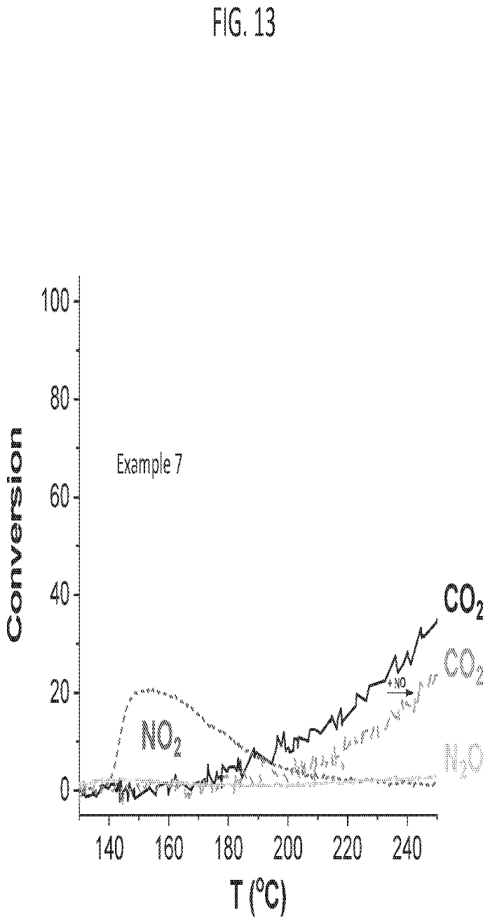

FIGS. 10 and 11 illustrate the uniqueness of the Ti additive when compared with other additives such as La (Example 5; FIG. 10) and Mn (Example 7; FIG. 11). By adding La or Mn onto the alumina support, the light-off performance diminished. However, once the Mn-containing sample reached light-off temperature, it converted HC more effectively, generating more CO₂ in the runs with NO in the feed than the runs without NO in the feed. This indicated, without wishing to be bound by theory, that the formation of NO₂ from the Mn-containing catalysts might help the absorbed HC to combust, yielding more CO₂ and more exotherm. To investigate this NO₂ formation from the Mn-containing catalysts further, an experiment was conducted without the use of PGM (platinum group metal; i.e., Pt), but with various additives (about 5% by weight) on alumina. Results shown in FIGS. 12 and 13 indicated that a Mn-containing support improved NO₂ formation at low temperature. This NO₂ formation feature translated to an improved HC conversion for the Pt on Mn-containing support sample (Example 7; FIG. 13), once the light-off takes place, as shown in FIG. 11.

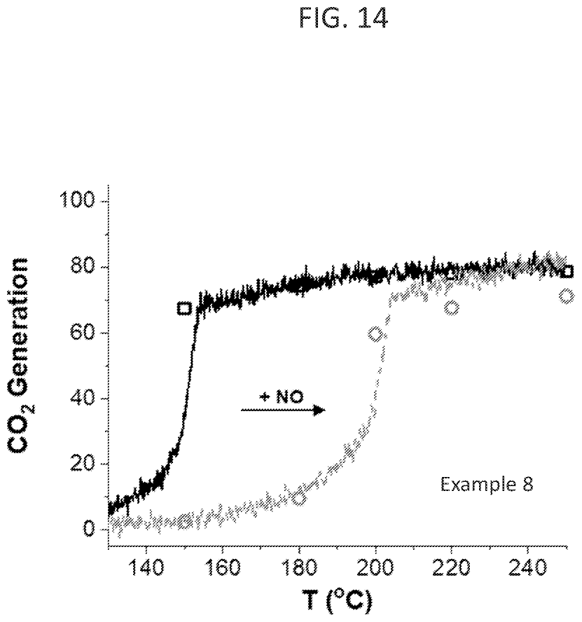

Operando results for Example 8 (FIG. 14) indicated that an alumina support with a large pore opening (40 nm) was better than the ones with a narrower pore opening (e.g., versus Examples 1 and 2; 10 nm pore openings). Without wishing to be bound by theory, it is believed a large pore-opening support may mitigate the masking better than the small pore-opening supports since the formation of polymeric substances (graphitic, coke, etc.) can deactivate a catalyst by masking the active sites.

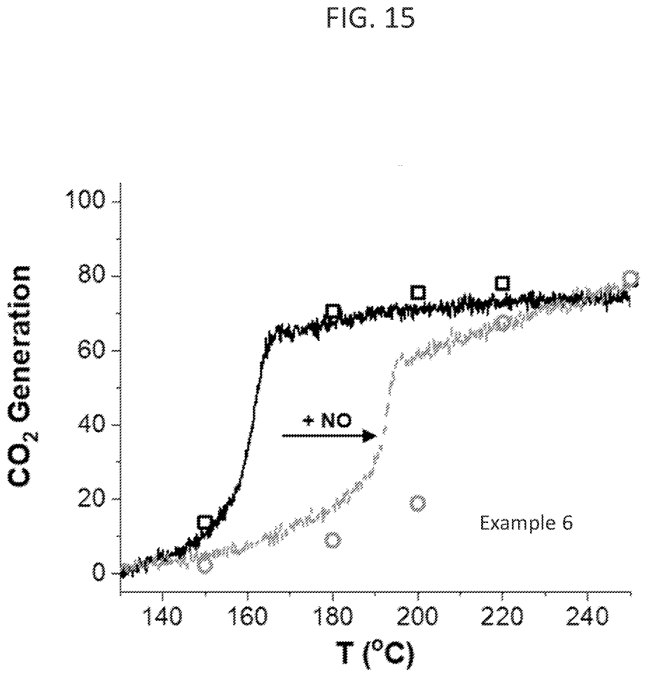

FIG. 15 illustrates the benefits of the Zr additive (Example 6). While its light-off temperature was not as low as for Examples 1 and 2 when NO was not in the feed gas, the tolerance to NO hindrance was relatively strong (FIG. 15). With NO in the feed, the CO₂ formation rate was comparable to inventive Example 3 and better than reference Examples 1 and 2. However, Example 6 tended to form polymeric substances with time, as shown in the steady state measurements (5 minutes at each temperature).

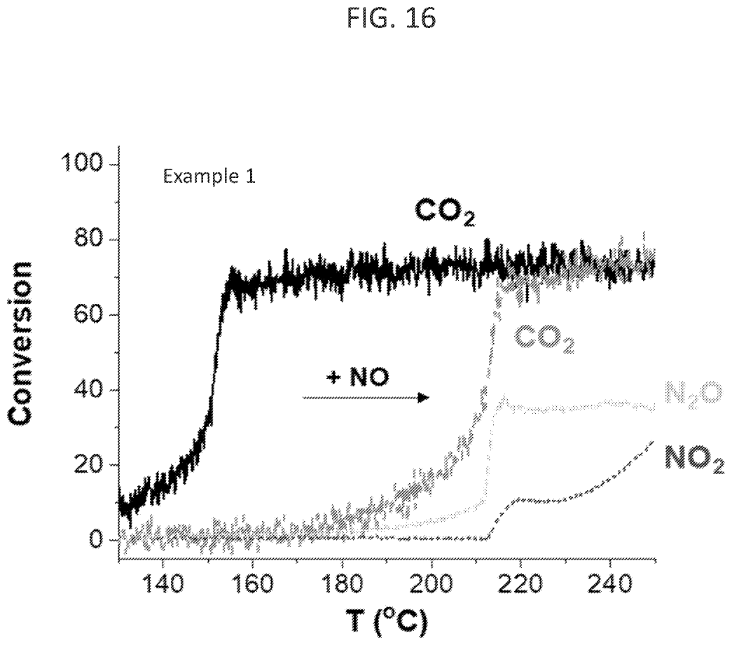

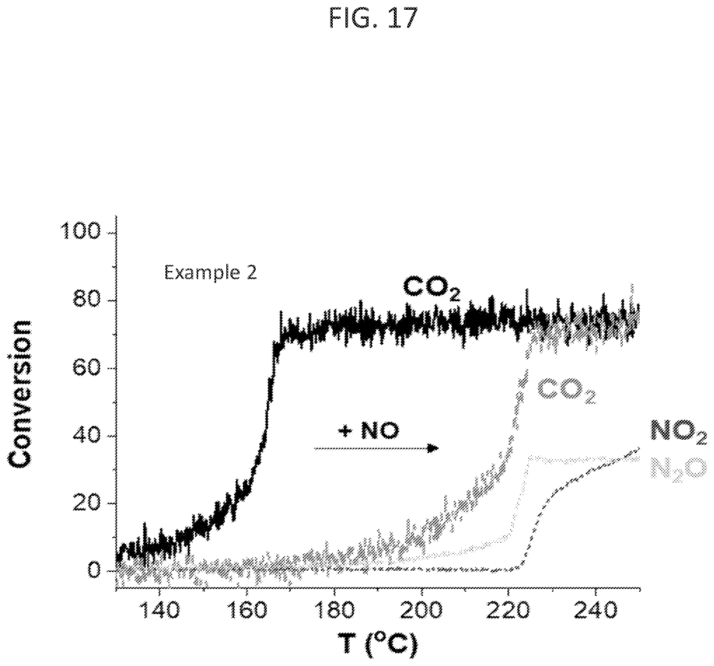

As manufacturers must meet the emission standards over the life of a vehicle, the performance of an emission catalyst must be durable for the entire vehicle useful life. Given this constraint, the aged catalysts were evaluated with respect to durability. Reference Examples 1 and 2 were evaluated in the same Operando setup, after aging at 650° C. for 20 hours, with 10% steam in air. It was clear that the reference Example 1 outperformed the reference Example 2 in CO₂ and N₂O formation, but lacked in NO₂ formation (FIGS. 16 and 17). Depending on the selection of downstream catalysts to be used following the catalyst composition as disclosed herein in the form of a ccDOC, reference Examples 1 or 2 may be useful in said ccDOC. For instance, the composition of Example 1 may be used if only an exotherm is needed, or the composition of Example 2 may be used if a SCR catalyst is to be located following the ccDOC.

As manufacturers prefer ccDOC light-off to be as fast as possible to shorten the time needed for the following downstream catalysts to become functional, the rate of the temperature rise of the catalyst composition and effluent thereof is an important factor in evaluating catalyst composition performance. Accordingly, embodiments of the disclosure were evaluated in this regard. The slopes of the CO₂ generating rate for the aged samples of Examples 1-3 were measured and are listed in Tables 2 and 3.

TABLE 2
Light-Off Slope without NO, %/degree

Light-Off Slope without NO, %/degree

| Example # | HC Conversion | CO₂ Formation |
|---|---|---|
| Example 1 | 11.2 | 8.3 |
| Example 2 | 9.6 | 8.2 |
| Example 3 | 14.5 | 8.7 |

Even without the NO in the feed, Example 3 outperformed both reference Examples 1 and 2 in HC conversion rate and CO₂ generation rate, indicating that a faster light-off and a higher exotherm were achieved with inventive Example 3. With NO added into the feed gas, the inventive Example 3 still outperformed both reference Examples 1 and 2 in both the HC conversion rate and the CO₂ generation rate, as shown in Table 3.

TABLE 3
Light-Off Slope with NO, %/degree

| | Light-Off Slope with NO, %/degree | | | |
|---|---|---|---|---|
| | HC | CO₂ | N₂O | NO₂ |
| Example # | Conversion | Formation | Formation | Formation |
| Example 1 | 6.9 | 7.5 | 6.7 | 1.9 |
| Example 2 | 6.2 | 6.1 | 4.8 | 3.4 |
| Example 3 | 7.4 | 7.9 | 15.4 | 4.5 |

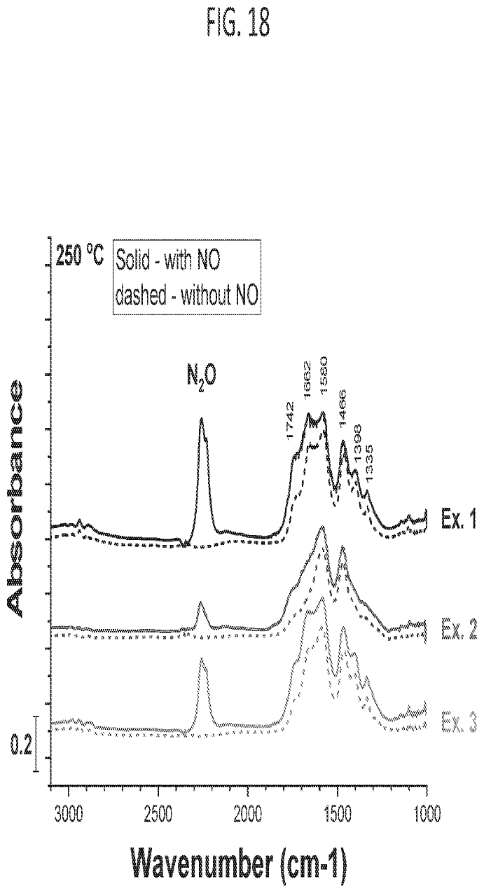

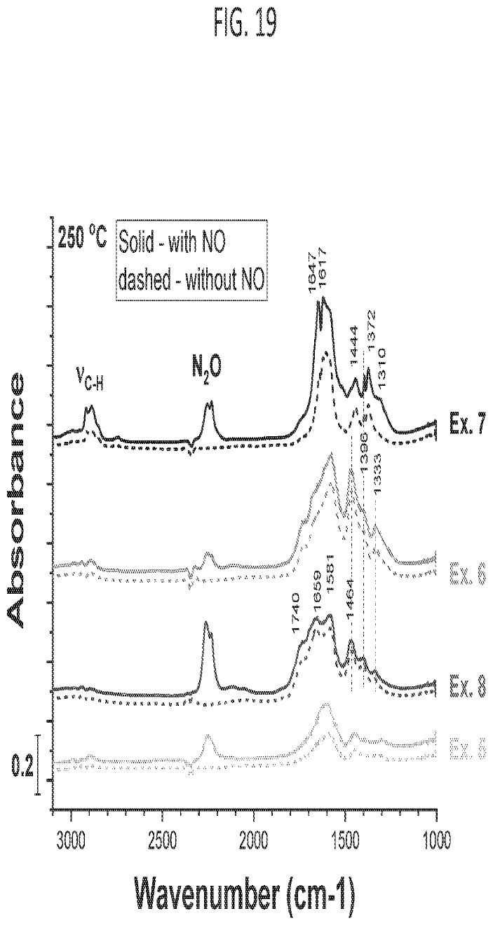

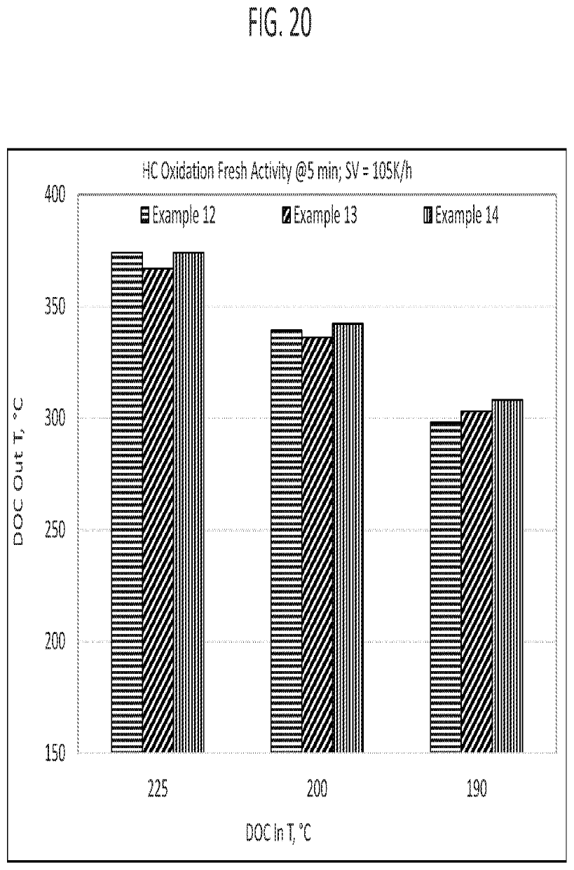

As the initiation of CO₂ formation coincides with the formation of N₂O, without wishing to be bound by theory, it is believed that the NO hindrance on the HC light-off is due to the blocking of the O₂ dissociation sites by NO molecules, and the quick conversion of NO to N₂O facilitates the removal of NO, hence the faster the HC light-off. This is supported by the FT-IR spectrum provided in FIG. 18. Similar results were observed for Examples 4 and 8, as shown in Table 4 and FIG. 19.

TABLE 4
Light-Off Slope with NO, %/degree

| | Light-Off Slope with NO, %/degree | | | |
|---|---|---|---|---|
| | HC | CO₂ | N₂O | NO₂ |
| Example # | Conversion | Formation | Formation | Formation |
| Example 3 | 7.4 | 7.9 | 15.4 | 4.5 |
| Example 4 | 8.9 | 8.6 | 7.9 | 4.2 |
| Example 8 | 8.0 | 9.3 | 8.4 | 3.0 |

The powder results indicated that both Ti doping and large pore-opening characteristics were helpful for HC light off temperature, regardless of whether NO was in the feed, indicating some synergism of Pt with Ti, and the Knudsen diffusion coefficient enhancement benefits through a large pore-opening support. The Ti doping changed the NO adsorption characteristics, and the large pore-opening of a support enhanced diffusion, allowing HC molecules to move quickly within the catalyst powders, thereby providing a fast HC light-off (Examples 5-8; FIG. 19).

### Core Sample Preparation

Monolithic coated articles were prepared using catalyst compositions prepared from the support materials previously described in Examples 2, 3, and 4 at a PGM loading of 200 g/ft³ and with a weight ratio of Pt:Pd of 10:1, by following the preparation method as described below. Unless otherwise noted, all parts and percentages are by weight, and all weight percentages, ratio are expressed on a dry basis, meaning excluding water content, unless otherwise indicated.

### Example 12. Reference Article

A catalyst composition was prepared by impregnating the support material of Example 2 (5% silica-alumina) with an aqueous solution of tetraamine platinum complex by adding it dropwise onto the dry powder under mixing. Subsequently, a solution of palladium nitrate was added to the Pt/support wet powder under the continuous planetary motion of mixing until a perfectly homogeneous mix of PGM onto the support material was obtained. This semi-wet powder was filled with de-ionized water to make a slurry at a solid content of 45%, and a pH about 4.5 adjusted with acetic acid. The well dispersed mixture was then loaded into a mill and the solid's particle size was reduced to D₉₀˜5.3 micron. The milled slurry was coated onto ceramic monolith substrates (1″ D×3″ L) at a washcoat dry gain of 1.92 g/in³. Coated parts were then placed into oven for drying at 120° C. for 2 hours and calcined at 590° C. for one hour.

### Example 13. Inventive Article

Example 13 was prepared using the method of Example 12, but substituting the support material of Example 4 (10% titania-alumina) for the silica-alumina.

### Example 14. Inventive Article

Example 14 was prepared using the method of Example 12, but substituting the support material of Example 3 (5% titania-alumina) for the silica-alumina.

### Results

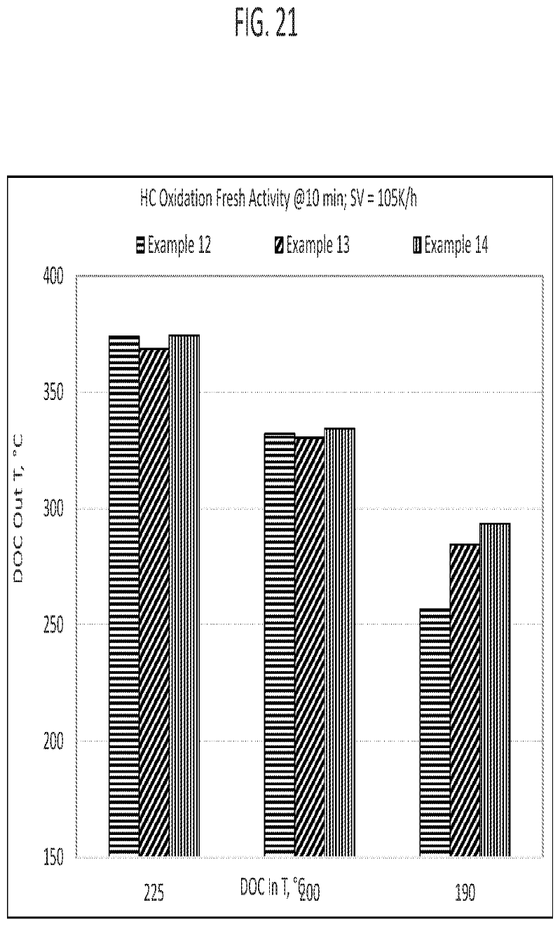

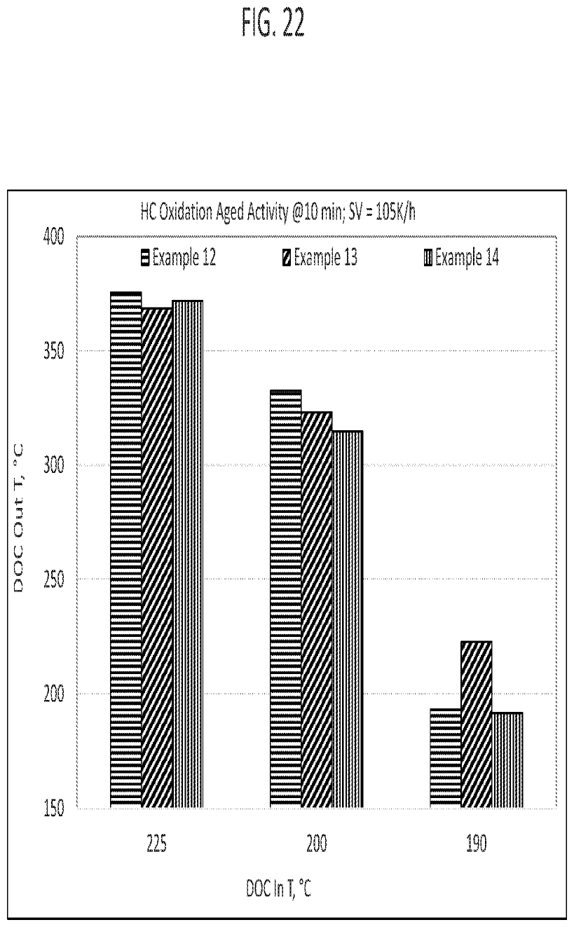

Cores of coated catalyst samples of Examples 12-14 were tested for their catalytic activity for hydrocarbon oxidation in a lab reactor employing a synthetic gas mix comprising 1000 ppm (C₁) HC derived from diesel fuel, 8% oxygen, 350 ppm NO, 5% H₂O, with the balance nitrogen at a space velocity of ˜100 K/h. Each sample was tested fresh and aged. Outlet temperatures for three DOC inlet temperatures (190, 200, and 225° C.) after 10 minutes of simulated diesel fuel injection are shown in FIGS. 20 and 21.

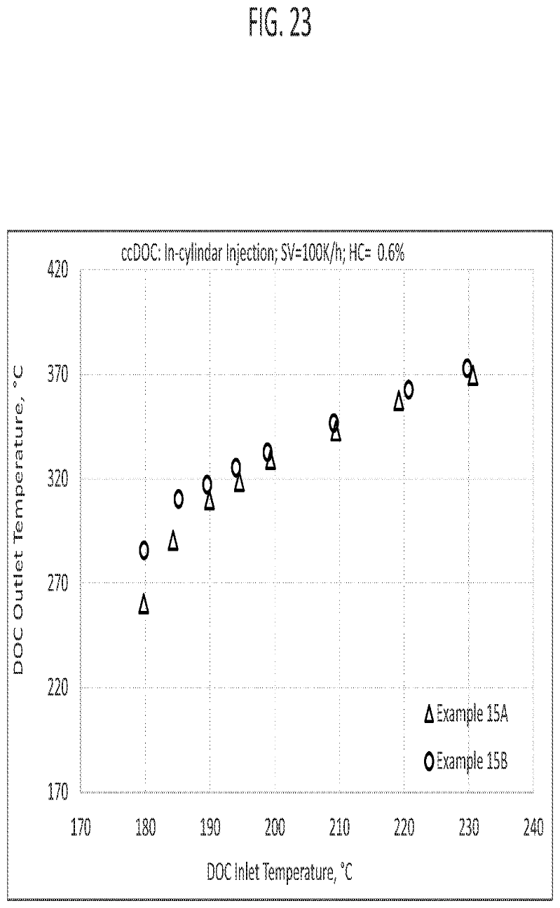

The results confirmed the powder (Operando) results (i.e., the Ti-containing alumina supports of Examples 13 and 14 improved the diesel fuel light off temperature, even with NO in the feed, relative to reference Example 12). After hydrothermal aging at 600° C. for 35 hours, each sample was tested again. Results (FIG. 22) confirmed the observations from the fresh samples, and confirmed the corresponding Operando results (i.e., the Ti-containing support improved the diesel fuel light-off temperature, even with NO in the feed).

### Example 15. Full-Size Article Preparation and Testing

A reference full-size catalyst article (Example 15A) was prepared according to Example 12, and an inventive full-size catalyst article (Example 15B) was prepared according to Example 13. Both full-size samples had the same PGM loading at 200 g/ft³ and a Pt/Pd ratio of 10 to 1. The substrate size was 9″ D×3″ L, 400 cpsi for both articles.

The articles of Examples 15A and 15B were tested on a commercial engine dynamometer (Cummins ISX engines) using in-cylinder fuel injection at steady-state temperature for 15 minutes, having the exhaust inlet temperature step down from 235° C. to 180° C., at stepwise decrement of about 10° C.

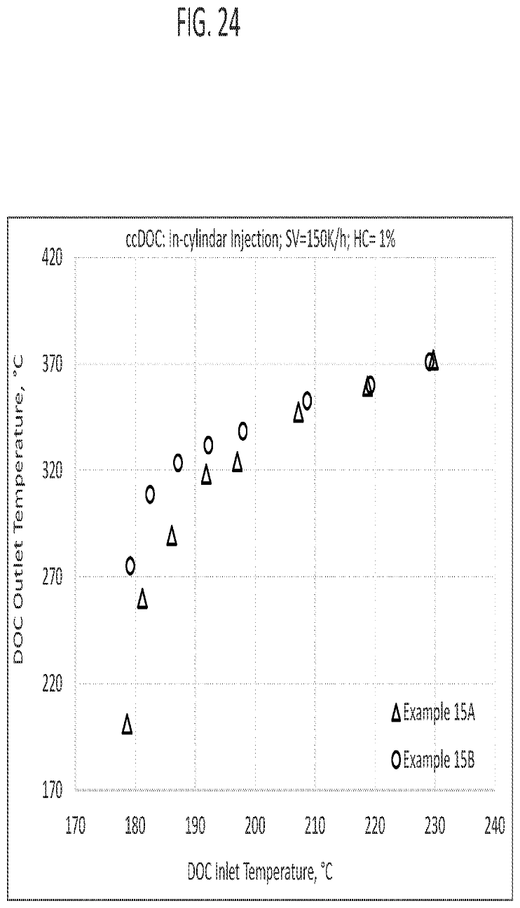

The results, averaged over 5 minutes and beginning 4 minutes from the point of injection, are provided in FIGS. 23 and 24 (6000 and 10,000 ppm diesel fuel injection, respectively). Example 15B clearly showed improved activity at temperatures below 200° C., as evidenced by a relatively higher DOC-out temperatures. These data validated the lab scale test results.

### Example 16. Acidity Measurement

Samples of compositions of Examples 1 (reference) and 4 were evaluated for Brönsted (proton donor) and Lewis (electron acceptor) acidity sites using the adsorption of pyridine as determined by Diffuse Reflectance Fourier-transform infrared spectroscopy (DRIFTS). Samples of the catalyst compositions (approximately 40 mg) were ground into a fine powder with an agate mortar and transferred into aluminum sample cups. The samples were dehydrated at 450° C. for 1 hour under flowing dry N₂ prior to conducting the acidity measurement. The samples were heated to 180° C. and 400° C. under flowing N₂ and maintained for 50 minutes, cooled, and DRIFT spectra were collected on a Thermo Scientific iS50 FTIR spectrometer equipped with a MCT detector and a Spectra-Tech diffuse reflectance high temperature chamber with KBr windows, allowing constant N₂ gas to flow through. Data are reported in Table 5.

TABLE 5
Pyridine IR-Acidity Measurements - μmoles/gram

| | Brönsted | Lewis acid | Sum of acid |
|---|---|---|---|
| | acid sites | sites | sites |
| | μmoles/gram | μmoles/gram | μmoles/gram |
| Example # | 180° C. | 180° C. | 180° C. |
| Example 1 (Reference) | 0 | 285.7 | 285.7 |
| Example 4 | 8.6 | 303.5 | 312.1 |
| Example 6 | 0 | 332 | 332 |

The results (Table 5) demonstrated that a high concentration of acidic sites (both Brönsted and Lewis sites, and particularly Brönsted sites) at a temperature in the range of the hydrocarbon light-off region (e.g., about 180° C.) was associated with the good hydrocarbon light-off performance in the presence of nitric oxide of Example 4. Without wishing to be bound by theory, it is believed that the high concentration of acidic sites, particularly Brönsted sites, in combination with the large pore diameter of the support material in inventive Example 4, is beneficial for minimizing nitric oxide inhibition of hydrocarbon light-off.

1. An oxidation catalyst composition for use in a close coupled diesel oxidation catalyst (ccDOC), wherein the oxidation catalyst composition comprises:
a high surface area alumina support material doped with at least one metal oxide; and
a platinum group metal (PGM) supported on the doped alumina support material;
wherein the ccDOC is operative at a space velocity of 100,000 h⁻¹ or greater to light off hydrocarbons at a temperature below about 250° C. in the presence of nitric oxide (NO); and wherein:
the doped high surface area alumina support material is a large pore material having an average pore opening size of at least about 15 nm; and/or
the doped high surface area alumina support material possesses a total acidity greater than 300 μmole per gram.

2. The oxidation catalyst composition of claim 1, wherein the doped high surface area alumina support material has a Brönsted acidity greater than 1 μmole per gram.

3. The oxidation catalyst composition of claim 1, wherein the at least one metal oxide is an oxide of titanium, silicon, manganese, iron, nickel, zinc, zirconium, tin, or any combination thereof.

4. The oxidation catalyst composition of claim 1, wherein the at least one metal oxide is chosen from silica, titania, manganese oxide, and combinations thereof.

5. The oxidation catalyst composition of claim 1, wherein the at least one metal oxide is titania.

6. The oxidation catalyst composition of claim 1, wherein the oxidation catalyst composition comprises from about 1% to about 20% by weight of the at least one metal oxide, based on the total weight of the oxidation catalyst composition.

7. The oxidation catalyst composition of claim 1, wherein the oxidation catalyst composition comprises from about 1% to about 10% by weight of the PGM, based on the total weight of the oxidation catalyst composition.

8. The oxidation catalyst composition of claim 1, wherein the PGM is platinum or a mixture of platinum and palladium.

9. The oxidation catalyst composition of claim 1, wherein the PGM is a mixture of platinum and palladium having a platinum to palladium ratio by weight of from about 1 to about 10.

10. The oxidation catalyst composition of claim 1, wherein the oxidation catalyst composition effectively oxidizes hydrocarbons (HC) in an exhaust gas stream comprising HC and nitrogen oxides (NOx), the exhaust gas stream having a HC to CO ratio of 100 or more.

11. The oxidation catalyst composition of claim 1, wherein the high surface area alumina support material has a surface area of at least about 90 m²/g.

12. The oxidation catalyst composition of claim 1, wherein the high surface area alumina support material has a surface area ranging from about 90 m²/g to about 150 m²/g.

13. The oxidation catalyst composition of claim 1, wherein the high surface area alumina support material is a large pore material having an average pore opening size of at least about 15 nm.

14. The oxidation catalyst composition of claim 1, wherein the high surface area alumina support material is a large pore material having an average pore opening size ranging from about 15 nm to about 200 nm, or from about 20 nm to about 50 nm.

15. The oxidation catalyst composition of claim 1, wherein the high surface area alumina support material is doped with from about 1% to about 20% titania by weight, based on the weight of the doped high surface area alumina support material.

16. The oxidation catalyst composition of claim 1, wherein the high surface area alumina support material is doped with from about 1% to about 10% titania by weight, or from about 3% to about 7% titania by weight, based on the weight of the doped high surface area alumina support material.

17. The oxidation catalyst composition of claim 15, further comprising manganese oxide.

18. The oxidation catalyst composition of claim 1, wherein the oxidation catalyst composition comprises from about 1% to about 5% by weight of platinum, palladium, or a mixture thereof, based on the total weight of the oxidation catalyst composition;
wherein the high surface area alumina support material is doped with from about 5% to about 10% titania by weight, based on the weight of the doped high surface area alumina support material; and
wherein the high surface area alumina support material has a surface area ranging from about 90 m²/g to about 150 m²/g, an average pore opening size of from about 15 nm to about 200 nm, or both

19. A system for treatment of an exhaust gas stream from an internal combustion engine containing hydrocarbons (HCs), carbon monoxide (CO), and nitrogen oxides (NOₓ), the system comprising:
a close coupled diesel oxidation catalyst (ccDOC) article located downstream of the internal combustion engine, wherein the ccDOC article comprises a substrate, and the oxidation catalyst composition of claim 1, disposed on at least a portion of the substrate;
a diesel oxidation catalyst (DOC) article located downstream of the engine and adapted for oxidation of HCs, CO and NOx; and
a selective catalytic reduction (SCR) article adapted for the reduction of nitrogen oxides (NOₓ), located downstream of the DOC article;
wherein all catalyst articles are in fluid communication with the exhaust gas stream.

20. A method for reducing HCs and NOₓ present in an exhaust gas stream from an internal combustion engine, the method comprising:
introducing a quantity of HCs into the exhaust stream to form an exhaust gas stream enriched in HCs;
contacting the HC-enriched exhaust gas stream with the oxidation catalyst composition of claim 1, wherein the oxidation catalyst composition is disposed on a substrate, and positioned downstream of the internal combustion engine in a close coupled position, to generate an exotherm by combustion of the HCs, thereby forming a heated, first effluent;
contacting the heated, first effluent with a diesel oxidation catalyst adapted for the oxidation of HCs and NO, thereby forming a second effluent with reduced levels of HCs and elevated levels of NO₂;
injecting a reductant into the second effluent exiting the diesel oxidation catalyst to obtain a third effluent; and
contacting the third effluent with a SCR catalyst adapted for the reduction of NOₓ, thereby forming a treated exhaust gas stream with reduced levels of HCs and NOₓ.
